(19) United States
(12) Patent Application Publication
(10) Pub. No.: US 2026/0261865 A1
(43) Pub. Date: Sep. 3, 2026

(54) COMMUNICATION CONTROL DEVICE, DATABASE DEVICE, COMMUNICATION CONTROL METHOD, AND INFORMATION PROCESSING METHOD

(71) Applicant: Sony Group Corporation, Tokyo (JP)

(72) Inventor: Sho FURUICHI, Tokyo (JP)

(73) Assignee: Sony Group Corporation, Tokyo (JP)

(21) Appl. No.: 19/163,198

(22) PCT Filed: Mar. 22, 2024
(86) PCT No.: PCT/JP2024/011416

§ 371 Date: Sep. 8, 2025

(30) Foreign Application Priority Data
Mar. 29, 2023 (JP) 2023-054265

(51) Int. Cl. H04W 16/14; H04W 28/16; H04W 52/24

(52) U.S. Cl. CPC H04W 16/14; H04W 28/16; H04W 52/24

(57) ABSTRACT

Provided are a communication control device, a database device, a communication control method, and an information processing method for supporting each of a plurality of operators to operate a communication device with a small operation load.

A communication control device of the present disclosure includes: a reception unit configured to receive a licensing request including information regarding a first area and a first spectrum range for which a first operator desires to acquire a license regarding spectrum use; a processing unit configured to determine whether or not to permit acquisition of the license by the first operator on the basis of the licensing request and licensing data including information regarding a second area and a second spectrum range for which a license has been acquired by a second operator; and a transmission unit configured to transmit a licensing response including information according to a determination result of the processing unit.

### TECHNICAL FIELD

The present disclosure relates to a communication control device, a database device, a communication control method, and an information processing method.

### BACKGROUND ART

In recent years, introduction of a spectrum licensing system for allocating a dedicated band to a vertical market is increasing in individual countries around the world, and introduction into the 3700-4200 MHz band or the 3800-4200 MHz band is accelerating in particular. As a representative example, there is a shared access license of Ofcom in the United Kingdom (Non-Patent Document 9). A low power shared access license (low power SAL) and a medium power shared access license (medium power SAL) are provided. The low power SAL gives authorization in units of circular regions with a radius of 50 meters to allow base stations to be freely installed in a license area, while the medium power SAL gives authorization in units of base station. Both the low power SAL and the medium power SAL are on the first-come first-served (FCFS) basis. Furthermore, in Canada, Innovation, Science and Economic Development Canada (ISED) has started, in August 2022, studies on introduction of non-competitive local licensing into the 3900-3980 MHz band (Non-Patent Document 10). In a system draft plan of ISED, similarly to Ofcom, it is assumed that a license is issued in the first-come, first-served (FCFS) system, and radius-based license areas and custom vector-based license areas are set as candidates as a method of determining a license area.

Both Ofcom in the United Kingdom and ISED in Canada are to consider transitioning these vertical-oriented licensing systems to a dynamic spectrum sharing (dynamic spectrum access (DSA))-based mechanism in the future. The DSA is a technology in which a spectrum management server unitarily performs registration management, spectrum use authorization, and the like of a base station, thereby promoting secondary use of temporal and spatial idle frequency resources while protecting radio wave use of a protection target system (existing system) in a target frequency band. For example, in the current mechanism, a maximum output that can be used is constant regardless of a location. However, in the DSA-based mechanism, there is a possibility that a higher output than a current regulation can be obtained depending on a location, since parameters of the base station can be dynamically adjusted according to time and the location.

### CITATION LIST

### Patent Document

Patent Document 1: WO 2021/187120 A

### Non-Patent Document

Non-Patent Document 1: WINNF-TS-0112-V1.9.1 “Requirements for Commercial Operation in the U.S. 3550-3700 MHz Citizens Broadband Radio Service Band” [available at https://cbrs.wirelessinnovation.org/release-1-of-the-baseline-standard-specifications]
Non-Patent Document 2: WINNF-SSC-0008-V1.3.0, “Spectrum Sharing Committee Policy and Procedure Coordinated Periodic Activities Policy”
Non-Patent Document 3: WINNF-TS-0061-V1.5.1 Test and Certification for Citizens Broadband Radio Service (CBRS); Conformance and Performance Test Technical Specification; SAS as Unit Under Test (UUT) [available at https://cbrs.wirelessinnovation.org/release-1-of-the-baseline-standard-specifications]
Non-Patent Document 4: WINNF-TS-0016-V1.2.4 Signaling Protocols and Procedures for Citizens Broadband Radio Service (CBRS): Spectrum Access System (SAS)—Citizens Broadband Radio Service Device (CBSD) Interface Technical Specification [available at https://cbrs.wirelessinnovation.org/release-1-of-the-baseline-standard-specifications]
Non-Patent Document 5: “940660 D02 CPE-CBSD Handshake Procedures v02”, Federal Communications Commission Office of Engineering and Technology Laboratory Division, October 2019, available at https://apps.fcc.gov/oetcf/kdb/forms/FTSSearchResultPage.cfm?id=229297&switch=P
Non-Patent Document 6: ECC Report 186 Technical and operational requirements for the operation of white space devices under geo-location approach [available at https://docdb.cept.org/document/293]
Non-Patent Document 7: Implementing TV White Spaces—Ofcom [available at https://www.ofcom.org.uk/_data/assets/pdf_file/0034/68668/tvws-statement.pdf]
Non-Patent Document 8: WINNF-TS-1001 V1.4.0, “CBRS Operational and Functional Requirements (Release 2)” [available at https://cbrs.wirelessinnovation.org/enhancements-to-baseline-specifications]
Non-Patent Document 9: Ofcom, “Shared access licenses”, available at: https://www.ofcom.org.uk/manage-your-license/radiocommunication-licenses/shared-access Non-Patent Document 10: ISED Canada, “Consultation on a Non-Competitive Local Licensing Framework, Including Spectrum in the 3900-3980 MHz Band and Portions of the 26, 28 and 38 GHz Bands”, August 2022, available at: https://ised-isde.canada.ca/site/spectrum-management-telecommunications/en/learn-more/key-documents/consultations/consultation-non-competitive-local-licensing-framework-including-spectrum-3900-3980-mhz-band-and

### SUMMARY OF THE INVENTION

### Problems to be Solved by the Invention

As a system in which the DSA technology is currently used, a citizens broadband radio service (CBRS) in the United States is known. In the CBRS, a spectrum access system (SAS) serves as a spectrum management server, and manages spectrum secondary use by a CBRS device (CBSD) while protecting an existing system from aggregate interference. Here, in the CBRS, a plurality of companies each operates the SAS. Therefore, in order to protect the existing system from aggregate interference, a synchronization process called coordinated periodic activities among SASs (CPAS) is performed between the SASs once a day. The synchronization process includes a process of sharing, between the SASs, registration information of the CBSD, information about a frequency channel being used and a maximum output, and protection area information of the CBSD called PAL protection area (PPA).

As described above, it is quite conceivable to allow each of a plurality of companies and organizations to operate the spectrum management server like the CBRS in a case where the vertical-oriented licensing system is shifted to the DSA type in the future. Considering convenience on a user side, it is not desirable to change a fundamental part of a licensing system, such as the first-come, first-served (FCFS) system. However, in a case where there is a plurality of spectrum management servers for the first-come, first-served (FCFS) licensing system, if the synchronization process such as the CPAS described above is frequently performed as the synchronization process of the plurality of spectrum management servers, there is a concern that an operation load increases. Therefore, it is desirable to perform the aggregate interference protection for the existing system through the synchronization process of the plurality of spectrum management servers with a small operation load by using a method different from the CPAS. Furthermore, regarding coexistence between vertical users, it is desirable to appropriately protect first-come users from subsequent users by using a similar mechanism.

The present disclosure provides a communication control device, a database device, a communication control method, and an information processing method for supporting each of a plurality of operators to operate a communication device with a small operation load.

### Solutions to Problems

A communication control device of the present disclosure includes: a reception unit configured to receive a licensing request including information regarding a first area and a first spectrum range for which a first operator desires to acquire a license regarding spectrum use; a processing unit configured to determine whether or not to permit acquisition of the license by the first operator on the basis of the licensing request and licensing data including information regarding a second area and a second spectrum range for which a license has been acquired by a second operator; and a transmission unit configured to transmit a licensing response including information according to a determination result of the processing unit.

### BRIEF DESCRIPTION OF DRAWINGS

FIG. 1 is a diagram illustrating a system model in an embodiment of the present disclosure.

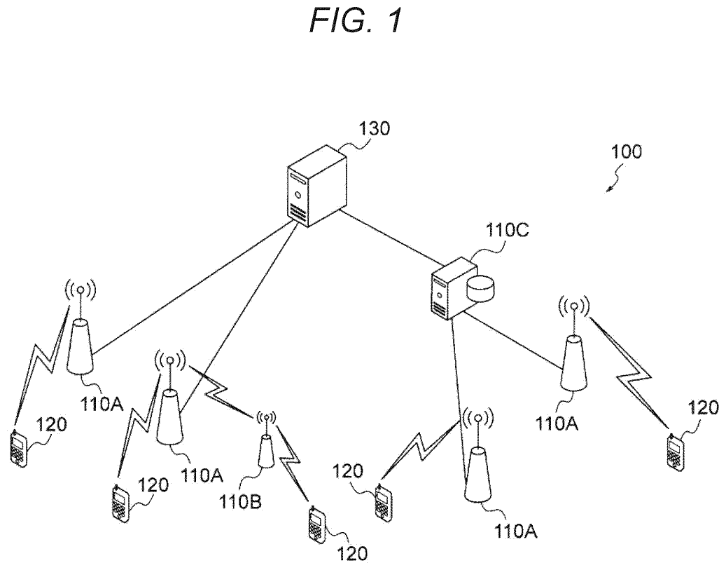

FIG. 2 is a diagram illustrating a network configuration to which autonomous decision-making can be applied.

FIG. 3 is a diagram illustrating a network configuration to which centralized decision-making can be applied.

FIG. 4 is a diagram illustrating a network configuration in a case where both centralized decision-making and distributed decision-making are applied.

FIG. 5 is a diagram for describing a three-tier structure in CBRS.

FIG. 6 is a diagram for describing a flow of signaling between terminals.

FIG. 7 is a diagram for describing an example of an architecture of a communication system according to a related technology.

FIG. 8 is a diagram illustrating the architecture of FIG. 7 from another viewpoint.

FIG. 9 is a diagram for describing an example of an architecture of a communication system according to the present embodiment.

FIG. 10 is a diagram for describing an example of data recorded in an IPC database.

FIG. 11 is a block diagram illustrating an example of a spectrum management server as a communication control device according to the present embodiment.

FIG. 12 is a block diagram illustrating an example of a licensing database as a database device according to the present embodiment.

FIG. 13 is a sequence diagram illustrating an example of a user registration procedure.

FIG. 14 is a sequence diagram illustrating an example of an area licensing procedure.

FIG. 15 is a diagram illustrating a relationship between a license area and a communication device installable area.

FIG. 16 is a sequence diagram illustrating an example of a flow of a communication device registration procedure.

FIG. 17 is a sequence diagram illustrating an example of a spectrum grant procedure.

FIG. 18 is a sequence diagram illustrating an example of a heartbeat procedure.

### MODE FOR CARRYING OUT THE INVENTION

Hereinafter, an embodiment of the present disclosure will be described in detail with reference to the drawings. In one or more embodiments described in the present disclosure, elements included in each of the embodiments can be combined with each other, and the combined resultant also forms part of the embodiments described in the present disclosure.

### 1. Assumed Representative Scenario

### <1.1 System Model>

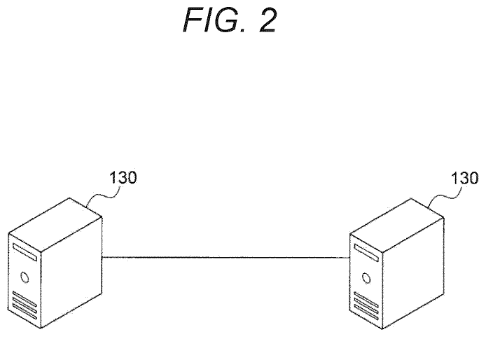

FIG. 2 illustrates a system model in an embodiment of the present invention. As illustrated in FIG. 2, this system model is represented by a communication network 100 including wireless communication, and typically includes the following entities.
Communication device 110
Terminal 120
Communication control device 130

Furthermore, this system model includes at least a primary system and a secondary system using the communication network 100. The primary system and the secondary system are configured by the communication device 110 or the communication device 110 and the terminal 120. Various communication systems can be treated as the primary system or the secondary system, but in the present embodiment, it is assumed that the primary system and the secondary system each use some or all of a frequency band. Note that the respective frequency bands allocated to the primary system and the secondary system may partially or entirely overlap or may not overlap at all. That is, this system model will be described as a model of a wireless communication system related to dynamic spectrum sharing (dynamic spectrum access (DSA)). Note that this system model is not limited to systems related to dynamic spectrum sharing.

Typically, the communication device 110 is a wireless device that provides a wireless communication service to the terminal 120, such as a wireless base station (Base Station, Node B, eNB, gNB, or the like) or a wireless access point. That is, the communication device 110 provides the wireless communication service to enable wireless communication of the terminal 120. Furthermore, the communication device 110 may be a wireless relay device or an optical extension device called a Remote Radio Head (RRH). In the following description, unless otherwise noted, the communication device 110 will be described as an entity constituting the secondary system.

The coverage (communication region) provided by the communication device 110 is allowed to have various sizes from a large size such as a macro cell to a small size such as a pico cell. Like a distributed antenna system (DAS), a plurality of the communication devices 110 may form one cell. Furthermore, in a case where the communication device 110 has a capability of beamforming, a cell or a service area may be formed for each beam.

In the present disclosure, it is assumed that there are two different types of communication devices 110.

In the present disclosure, the communication device 110 that can access the communication control device 130 without using a wireless path that requires permission of the communication control device 130 is referred to as a “communication device 110A”. Specifically, for example, the communication device 110 capable of a wired Internet connection can be regarded as the “communication device 110A”. Furthermore, for example, even in a wireless relay device that does not have a wired Internet connection function, if a wireless backhaul link using a spectrum that does not require permission of the communication control device 130 is constructed with another communication device 110A, such a wireless relay device may also be regarded as the “communication device 110A”.

In the present disclosure, the communication device 110 that cannot access the communication control device 130 without a wireless path that requires permission of the communication control device 130 is referred to as a “communication device 110B”. For example, a wireless relay device that needs to construct a backhaul link using a spectrum that requires permission of the communication control device 130 can be regarded as the “communication device 110B”. Furthermore, for example, a device such as a smartphone having a wireless network provision function represented by tethering and using a spectrum that requires permission of the communication control device 130 in both the backhaul link and the access link may be treated as the “communication device 110B”.

The communication device 110 is not necessarily fixedly installed. For example, the communication device 110 may be installed in a mobile object such as an automobile. Furthermore, the communication device 110 does not necessarily need to exist on the ground. For example, the communication device 110 may be included in an object existing in the air or space, such as an aircraft, a drone, a helicopter, a high altitude platform station (HAPS), a balloon, or a satellite. Furthermore, for example, the communication device 110 may be included in an object existing on the sea or under the sea, such as a ship or a submarine. Typically, such a mobile communication device 110 corresponds to the communication device 110B, and performs wireless communication with the communication device 110A to secure an access path to the communication control device 130. As a matter of course, even the mobile communication device 110 can be treated as the communication device 110A as long as the spectrum used in the wireless communication with the communication device 110A is not managed by the communication control device 130.

In the present disclosure, unless otherwise specified, the description “communication device 110” includes both meanings of the communication device 110A and the communication device 110B, and may be replaced with either one.

The communication device 110 can be used, operated, or managed by various operators. For example, a mobile network operator (MNO), a mobile virtual network operator (MVNO), a mobile network enabler (MNE), a mobile virtual network enabler (MVNE), a shared facility operator, a neutral host network (NHN) operator, a broadcaster, an enterprise, an educational institution (educational institutions, respective boards of education of local governments, or the like), a real estate (building, apartment, or the like) administrator, an individual, and the like can be assumed as operators related to the communication device 110. Note that the operator related to the communication device 110 is not particularly limited. Furthermore, the communication device 110A may be a shared facility used by a plurality of operators. Furthermore, different operators may perform installation, use, and management of the facilities.

The communication device 110 operated by the operator is typically connected to the Internet via a core network. Furthermore, operation, management, and maintenance are performed by a function called Operation, Administration & Maintenance (OA&M). Furthermore, for example, as illustrated in FIG. 2, there may be an intermediate device (network manager) 110C that centrally controls the communication devices 110 in the network. Note that there may be cases where the intermediate device is the communication device 110 or cases where the intermediate device is the communication control device 130.

The terminal 120 (User Equipment, User Terminal, User Station, Mobile Terminal, Mobile Station, or the like) is a device that performs wireless communication using a wireless communication service provided by the communication device 110. Typically, communication equipment such as a smartphone corresponds to the terminal 120. Note that a device having a wireless communication function can correspond to the terminal 120. For example, equipment such as a business camera having a wireless communication function can also correspond to the terminal 120 even if the wireless communication is not a main application. Furthermore, communication equipment that transmits data to the terminal 120, such as a wireless station for broadcasting business (field pickup unit (FPU)) that transmits an image for television broadcasting or the like from an outside (site) of a broadcast station to the broadcast station in order to broadcast sports or the like, also corresponds to the terminal 120. Furthermore, the terminal 120 is not necessarily used by a person. For example, like what is called machine type communication (MTC), equipment such as a factory machine or a sensor installed in a building may be network-connected to operate as the terminal 120. Furthermore, a device called customer premises equipment (CPE) provided to ensure connection to the Internet may behave as the terminal 120.

Furthermore, as represented by device-to-device (D2D) and vehicle-to-everything (V2X), the terminal 120 may include a relay communication function.

Furthermore, similarly to the communication device 110, the terminal 120 need not be fixedly installed or exist on the ground. For example, an object existing in the air or space, such as an aircraft, a drone, a helicopter, a satellite, or the like, may operate as the terminal 120. Furthermore, for example, an object existing on the sea or under the sea, such as a ship or a submarine, may operate as the terminal 120.

In the present disclosure, unless otherwise noted, the terminal 120 corresponds to an entity where a wireless link using a spectrum that requires permission of the communication control device 130 terminates. However, depending on a function included in the terminal 120 or an applied network topology, the terminal 120 can perform an operation equivalent to that of the communication device 110. In other words, depending on the network topology, there may be cases where a device that can correspond to the communication device 110 such as a wireless access point corresponds to the terminal 120, or cases where a device that can correspond to the terminal 120 such as a smartphone corresponds to the communication device 110.

The communication control device 130 is typically a device that determines, permits, gives an instruction on, and/or manages communication parameters of the communication device 110. For example, database servers called TV white space database (TVWSDB), geolocation database (GLDB), spectrum access system (SAS), and automated frequency coordination (AFC) correspond to the communication control device 130. In other words, a database server having an authority and a role such as authentication and supervision of radio wave use related to secondary use of a spectrum can be regarded as the communication control device 130.

The communication control device 130 also corresponds to a database server having a role different from the above-described role. For example, a control device that performs radio wave interference control between communication devices represented by a Spectrum Manager (SM) in EN 303 387 of the European Telecommunications Standards Institute (ETSI), a Coexistence Manager (CM) in the Institute of Electrical and Electronics Engineers (IEEE) 802.19.1-2018, a Coexistence Manager (CxM) in CBRSA-TS-2001, or the like also corresponds to the communication control device 130. Furthermore, for example, a registered location secure server (RLSS) defined in IEEE 802.11-2016 also corresponds to the communication control device 130. That is, not limited to these examples, an entity responsible for determination, use permission, instruction, management, and the like of the communication parameters of the communication device 110 may be referred to as the communication control device 130. Basically, the control target of the communication control device 130 is the communication device 110, but the communication control device 130 may control the terminal 120 subordinate to the communication device 110.

The communication control device 130 also corresponds to a combination of a plurality of database servers having different roles. For example, CBRS Alliance SAS (CSAS) which is a combination of SAS and CxM illustrated in CBRSA-TS-2001 can also be regarded as the communication control device 130.

The communication control device 130 can also be implemented by software having a function equivalent to that of the database server installed on one database server. For example, a SAS having a function or software equivalent to CxM can also be regarded as the communication control device 130.

There may be a plurality of communication control devices 130 having similar roles. In a case where there is the plurality of communication control devices 130 having similar roles, at least one of the following three types of decision-making topologies can be applied to the communication control device 130.
Autonomous decision-making
Centralized decision-making
Distributed decision-making

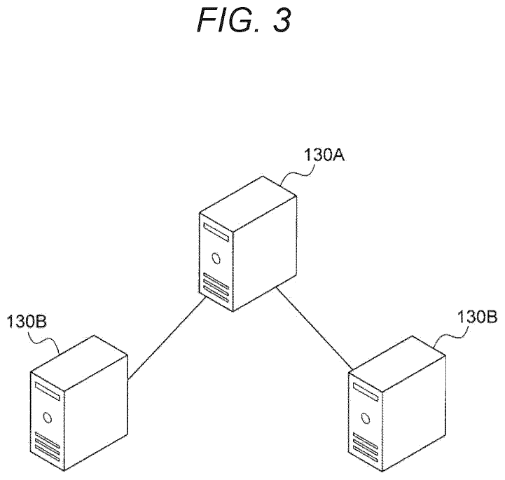

The autonomous decision-making is a decision-making topology in which an entity (the decision-making entity, here the communication control device 130) that makes a decision makes a decision independently from another decision-making entity. The communication control device 130 independently calculates necessary spectrum allocation and interference control. For example, in a case where a plurality of communication control devices 130 is arranged in a distributed manner as illustrated in FIG. 3, the autonomous decision-making can be applied.

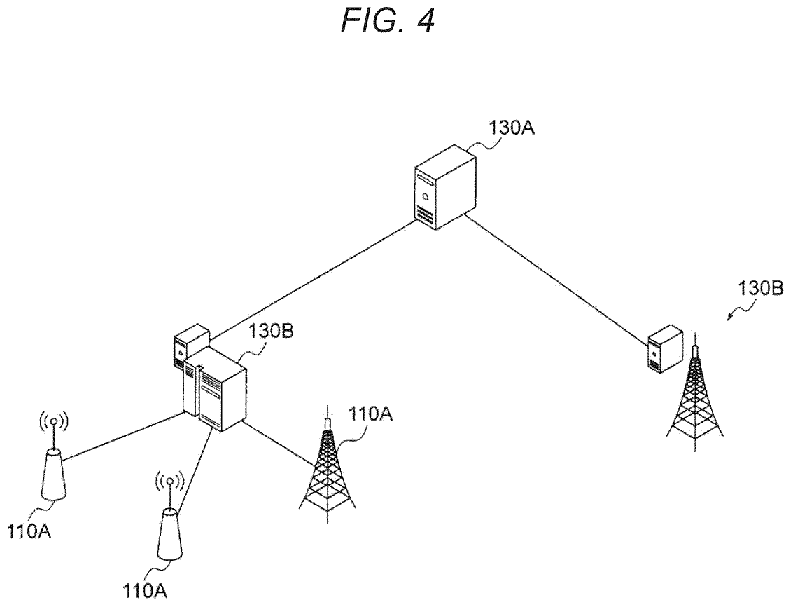

The centralized decision-making is a decision-making topology in which a decision-making entity delegates decision-making to another decision-making entity. In a case where the centralized decision-making is performed, for example, a model as illustrated in FIG. 4 can be assumed. FIG. 4 illustrates a model (what is called master-slave type) in which one communication control device 130 performs centralized control of the plurality of communication control devices 130. In the model of FIG. 4, the communication control device 130A, which is the master, can control the communication control devices 130B, which are a plurality of slaves, to intensively make decisions.

The distributed decision-making is a decision-making topology in which a decision-making entity makes a decision in cooperation with another decision-making entity. For example, while a plurality of communication control devices 130 independently makes a decision as in the autonomous decision-making in FIG. 3, mutual adjustment of decision-making results, negotiation, and the like performed by each communication control device 130 after making a decision may correspond to “distributed decision-making”. Furthermore, for example, in the centralized decision-making in FIG. 4, for the purpose of load balancing or the like, performing dynamic delegation of decision-making authority to each slave communication control device 130B, deletion thereof, or the like by the master communication control device 130A can also be regarded as “distributed decision-making”.

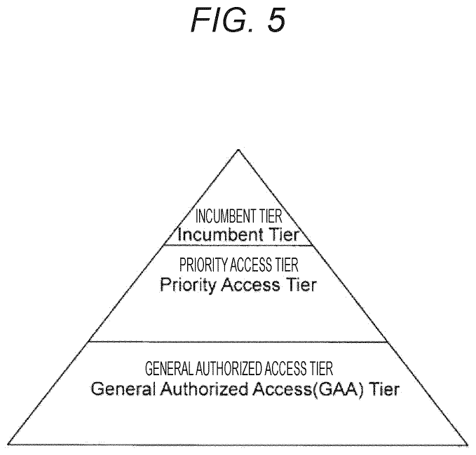

There may be cases where both the centralized decision-making and the distributed decision-making are applied. In FIG. 5, the slave communication control device 130B operates as an intermediate device that bundles the plurality of communication devices 110. It is not necessary for the master communication control device 130A to control the communication devices 110 bundled by the slave communication control device 130B, that is, the secondary system configured by the slave communication control device 130B. As described above, as a modification, implementation as illustrated in FIG. 5 is also possible.

The communication control device 130 may also acquire necessary information from entities other than the communication device 110 and the terminal 120 of the communication network 100 for its role. Specifically, for example, information necessary for protecting the primary system can be acquired from a database (regulatory database) managed or operated by a radio administration agency (national regulatory authority (NRA)) of a country or a region. Examples of the regulatory database include the Universal Licensing System (ULS) operated by the Federal Communications Commissions (FCC), and the like. Examples of information necessary for protecting the primary system include, for example, position information of the primary system, communication parameters of the primary system, an out-of-band emission (OOBE) limit, an adjacent channel leakage ratio (ACLR), adjacent channel selectivity, a fading margin, a protection ratio (PR), and the like. In a region where a fixed numerical value, an acquisition method, a derivation method, and the like are defined by a law or the like in order to protect the primary system, it is desirable to use information defined by the law as information necessary for protecting the primary system.

Furthermore, a database that records the communication device 110 and the terminal 120 that have been subjected to conformity authentication, such as an equipment authorization system (EAS) managed by the Office of Engineering and Technology (OET) of the FCC, also corresponds to the regulatory database. From such a regulatory database, it is possible to acquire information regarding an operable spectrum of the communication device 110 or the terminal 120, information regarding maximum equivalent isotropic radiated power (EIRP), and the like. Naturally, the communication control device 130 may use these pieces of information for protecting the primary system.

Furthermore, it can also be assumed that the communication control device 130 acquires radio wave sensing information from a radio wave sensing system installed and operated for the purpose of radio wave detection in the primary system. As a specific example, in the citizens broadband radio service (CBRS) in the United States, the communication control device 130 acquires radio wave detection information of a ship radar as a primary system from a radio wave sensing system called an environmental sensing capability (ESC). Furthermore, in a case where the communication device 110 and the terminal 120 have a sensing function, the communication control device 130 may acquire radio wave detection information of the primary system from these.

Furthermore, it can also be assumed that the communication control device 130 acquires activity information of the primary system from a portal system that manages the activity information of the primary system. As a specific example, in the citizens broadband radio service (CBRS) in the United States, the communication control device 130 acquires the activity information of the primary system from a calendar-type system called Informing Incumbent Portal. Protection of the primary system is achieved by enabling a protection area called Dynamic Protection Area (DPA) on the basis of the acquired activity information. Protection of the primary system is also implemented by an equivalent system called Informing Incumbent Capability (IIC) in a similar manner.

The interface between the respective entities constituting this system model may be wired or wireless. For example, not only a wired line but also a wireless interface that does not depend on spectrum sharing may be used as an interface between the communication control device 130 and the communication device 110. Examples of the wireless interface that does not depend on spectrum sharing include, for example, a wireless communication line provided by a mobile network operator via a licensed band, Wi-Fi communication using an existing license-exempt band, and the like.

### <1.2 Terms Related to Spectrum and Sharing>

As described above, the present embodiment will be described assuming a dynamic spectrum sharing (Dynamic Spectrum Access) environment. As a representative example of the dynamic spectrum sharing, a mechanism defined by the CBRS in the United States (that is, a mechanism defined in Part 96 Citizens Broadband Radio Service of the FCC Rules of the United States) will be described.

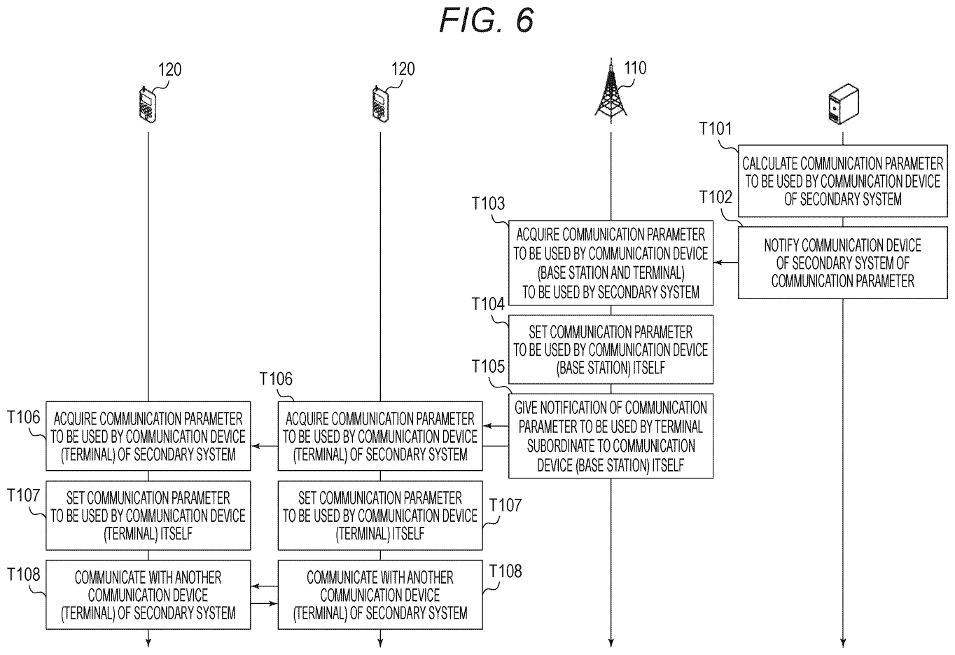

In the CBRS, as illustrated in FIG. 6, each of users in the frequency band is classified into one of three groups. This group is referred to as a tier. The three groups are referred to as an Incumbent Tier, a Priority Access Tier, and a General Authorized Access (GAA) Tier, respectively.

The Incumbent Tier is a group including existing users who conventionally use frequency bands. The existing user is also generally referred to as a primary user. In the CBRS, the Department of Defense (DOD), fixed satellite operators, and new rule excepted radio broadband licensees (Grandfathered Wireless Broadband Licensees (GWBL)) in the United States are defined as existing users. The Incumbent Tier is not required to avoid interference to the Priority Access Tier and the GAA Tier with lower priorities or to suppress use of the frequency band. Furthermore, the Incumbent Tier is protected from interference by the Priority Access Tier and the GAA Tier. That is, users of the Incumbent Tier can use the frequency band without considering the existence of other groups.

The Priority Access Tier is a group including users who use the frequency band on the basis of the above-described priority access license (PAL). A user of the Priority Access Tier is also generally referred to as a secondary user. When the frequency band is used, the Priority Access Tier is required to avoid interference and to suppress use of the frequency band for the Incumbent Tier having a higher priority than the Priority Access Tier. On the other hand, neither avoiding interference nor suppressing use of the frequency band is required for the GAA Tier having a lower priority than the priority access tier. Furthermore, the Priority Access Tier is not protected from interference by the Incumbent Tier with a higher priority, but is protected from interference by the GAA Tier with a lower priority.

The GAA Tier is a group including frequency band users that do not belong to the Incumbent Tier and the Priority Access Tier. Similarly to the Priority Access Tier, in general, a user of the GAA Tier is also referred to as a secondary user. However, since the priority of shared use is lower than that of the Priority Access Tier, it is also referred to as a low priority secondary user. When the frequency band is used, the GAA Tier is required to avoid interference and suppress use of the frequency band for the Incumbent Tier and the Priority Access Tier having higher priorities. Furthermore, the GAA Tier is not protected from interference by the Incumbent Tier and Priority Access Tier with higher priority.

Although the CBRS mechanism has been described above as a representative example of the dynamic spectrum sharing, the present embodiment is not limited to the definition of CBRS. For example, as illustrated in FIG. 6, the CBRS generally employs a three-tier structure, but a two-tier structure may be employed in the present embodiment. Representative examples of the two-tier structure include Authorized Shared Access (ASA), Licensed Shared Access (LSA), evolved LSAs (eLSAs), TV band white space (TVWS), US 6 GHz band sharing, and the like. In the ASA, the LSA, and the eLSA, there is no GAA Tier, and a structure equivalent to a combination of the Incumbent Tier and the Priority Access Tier is employed. Furthermore, in the TVWS and the US 6 GHz band sharing, there is no Priority Access Tier, and a structure equivalent to a combination of the Incumbent Tier and the GAA Tier is employed. Furthermore, there may be four or more tiers. Specifically, for example, four or more tiers may be generated by providing a plurality of intermediate layers corresponding to the Priority Access Tiers and giving different priorities to the respective intermediate layers, and the like. Furthermore, for example, the tiers may be increased by similarly dividing the GAA Tier and giving priorities, and the like. That is, each group may be divided.

Furthermore, the primary system of the present embodiment is not limited to the definition of the CBRS. For example, as an example of the primary system, a wireless system such as TV broadcasting, a fixed microwave line (fixed system (FS)), a meteorological radar, a radio altimeter, a wireless train control system (communications-based train control), and a radio astronomy are assumed. Furthermore, the present embodiment is not limited thereto, and any wireless system can be the primary system of the present embodiment.

Furthermore, as described above, the present embodiment is not limited to the environment of spectrum sharing. In general, in spectrum sharing or spectrum secondary use, an existing system that uses a target frequency band is referred to as a primary system, and a secondary user is referred to as a secondary system. However, in a case where the present embodiment is applied to an environment other than the spectrum sharing environment, they should be read by replacing with other terms. For example, a macrocell base station in a heterogeneous network (HetNet) may be the primary system, and a small cell base station or a relay station may be the secondary system. Furthermore, the base station may be the primary system, and a relay user equipment (Relay UE) or a Vehicle UE that implements D2D or V2X existing within its coverage may be the secondary system. The base station is not limited to a fixed type, and may be a portable type or a mobile type. In such a case, for example, the communication control device 130 of the present embodiment may be included in a core network, a base station, a relay station, a Relay UE, or the like.

Furthermore, in a case where the present embodiment is applied to an environment other than the spectrum sharing environment, the term “spectrum” in the present disclosure is replaced with another term shared by the application destination. For example, terms such as “resource”, “resource block”, “resource element”, “resource pool”, “channel”, “component carrier”, “carrier”, “subcarrier”, and “bandwidth part (BWP)”, or another term having a meaning equivalent or similar thereto are assumed to be used.

### <<2. Description of Various Procedures Assumed in Present Embodiment>>

Here, a basic procedure that can be used in the implementation of the present embodiment will be described. Note that up to <2.5> described later will be described on the assumption that the process is mainly performed in the communication device 110A.

### <2.1 Registration Procedure>

A registration procedure is a procedure for registering information of a wireless system that intends to use the frequency band. More specifically, it is a procedure for registering device parameters related to the communication device 110 of the wireless system in the communication control device 130. Typically, the registration procedure is started by that the communication device 110 representing a wireless system that intends to use the frequency band notifies the communication control device 130 of a registration request including the device parameters. Note that, in a case where a plurality of the communication devices 110 belongs to the wireless system that intends to use the frequency band, the device parameters of each of the plurality of communication devices is included in the registration request. Furthermore, a device that transmits the registration request as a representative of the wireless system may be appropriately determined.

### <2.1.1 Details of Required Parameters>

The device parameter refers to, for example, the following information.
Information regarding a user of the communication device 110 (hereinafter described as user information)
Information unique to the communication device 110 (hereinafter described as unique information)
Information regarding a position of the communication device 110 (hereinafter described as position information)
Information regarding an antenna included in the communication device 110 (hereinafter described as antenna information)
Information regarding the wireless interface included in the communication device 110 (hereinafter described as wireless interface information)
Legal information regarding the communication device 110 (hereinafter described as legal information)
Information regarding an installer of the communication device 110 (hereinafter described as installer information)
Information regarding the group to which the communication device 110 belongs (hereinafter, group information)

The device parameter is not limited to the above. Information other than these may be treated as the device parameters. Note that the device parameters do not need to be transmitted at once, and may be transmitted in a divided manner a plurality of times. That is, a plurality of registration requests may be transmitted for one registration procedure. In this manner, one procedure or one process in the procedure may be performed a plurality of times. This similarly applies to the procedure described below.

The user information is information related to the user of the communication device 110. For example, a user ID, an account name, a user name, a user contact address, a call sign, and the like can be assumed. The user ID and the account name may be independently generated by the user of the communication device 110 or may be issued in advance by the communication control device 130. As the call sign, it is desirable to use a call sign issued by the NRA.

The user information can be used, for example, in an application of interference resolution. As a specific example, in a spectrum use notification procedure described in <2.5> to be described later, even if the communication control device 130 makes the use stop determination on the spectrum being used by the communication device 110 and gives an instruction based on the use stop determination, there may be a case where notification of a spectrum use notification request of the spectrum is continuously provided. In this case, suspecting a failure of the communication device 110, the communication control device 130 can give a behavior check request for the communication device 110 to the user contact address included in the user information. Not limited to this example, in a case where it is determined that the communication device 110 is performing an operation against communication control performed by the communication control device 130, the communication control device 130 can make a contact using the user information.

The unique information is information that can specify the communication device 110, product information of the communication device 110, information regarding hardware or software of the communication device 110, and the like.

The information that can specify the communication device 110 can include, for example, a manufacturing number (serial number) of the communication device 110, an ID of the communication device 110, and the like. The ID of the communication device 110 may be uniquely given by the user of the communication device 110, for example.

The product information of the communication device 110 can include, for example, information regarding an authentication ID, a product model number, a manufacturer, and the like. The authentication ID is, for example, an ID given from a certificate authority in each country or region, such as an FCC ID in the United States, a CE number in Europe, and a technical standards conformity certification (technical conformity) in Japan. An ID issued by an industry association or the like on the basis of a unique authentication program may also be regarded as the authentication ID.

The unique information represented by these may be used, for example, for a permission list (allowlist) or a denial list (denylist). For example, in a case where any piece of information regarding the communication device 110 in operation is included in the denial list, the communication control device 130 can instruct the communication device 110 to stop spectrum use in the spectrum use notification procedure described in <2.5> described later. Moreover, the communication control device 130 can take a behavior of not canceling the use stop measure until the communication device 110 is cancelled from the denial list. Furthermore, for example, the communication control device 130 can reject registration of the communication device 110 included in the denial list. Furthermore, for example, the communication control device 130 can also perform an operation that does not consider the communication device 110 corresponding to the information included in the denial list in the interference calculation of the present disclosure or that considers only the communication device 110 corresponding to the information included in the permission list in the interference calculation.

Note that, in the present disclosure, the FCC ID may be used as information regarding transmission power. For example, in an equipment authorization system (EAS) database, which is a type of regulatory database, information regarding a device for which authentication has been acquired can be acquired, and an application programming interface (API) thereof is also disclosed. For example, certified maximum EIRP information or the like can be included in the information together with the FCC ID. Since such power information is linked with the FCC ID, the FCC ID can be handled as transmission power information. Similarly, the FCC ID may be treated as equivalent to other information included in the EAS. Furthermore, not limited to the FCC ID, in a case where information linked with the authentication ID is present, the authentication ID may be treated as equivalent to the information.

The information regarding the hardware of the communication device 110 can include, for example, transmission power class information. For example, in Title 47 Code of Federal Regulations (C.F.R) Part 96 in the United States, two types of classes Category A and Category B are defined as the transmission power class information, and information regarding the hardware of the communication device 110 conforming to the definition can include information regarding which of the two types of classes it belongs to. Furthermore, in TS36.104 and TS38.104 of 3rd Generation Partnership Project (3GPP), some classes of eNodeB and gNodeB are defined, and these definitions can also be used.

The transmission power class information can be used, for example, in an application of interference calculation. The interference calculation can be performed using the maximum transmission power defined for each class as the transmission power of the communication device 110.

The information regarding the software of the communication device 110 can include, for example, version information, a build number, and the like regarding an execution program in which a process necessary for interaction with the communication control device 130 is described. Furthermore, version information, a build number, and the like of software for operating as the communication device 110 may also be included.

The position information is typically information that can specify the position of the communication device 110. For example, it is coordinate information acquired by a positioning function represented by the Global Positioning System (GPS), Beidou, the Quasi-Zenith Satellite System (QZSS), Galileo, or the Assisted Global Positioning System (A-GPS). Typically, information related to latitude, longitude, ground level or sea level, altitude, and positioning error can be included. Alternatively, for example, the position information may be position information registered in an information management device managed by the National Regulatory Authority (NRA) or its entrusted institution. Alternatively, for example, coordinates of an X axis, a Y axis, and a Z axis with a specific geographical position as an origin may be used. Furthermore, together with such coordinate information, an identifier indicating whether the communication device 110 exists outdoors or indoors can be given.

Furthermore, the position information may include positioning accuracy information (location uncertainty). For example, both or one of a horizontal plane and a vertical plane may be provided as the positioning accuracy information. For example, the positioning accuracy information (location uncertainty) can be used as a correction value when calculating a distance to any point. Furthermore, for example, the positioning accuracy information can also be used as region information in which the communication device 110 is likely to be located. In this case, it is used for a process of specifying spectrum information that can be used in the region indicated by the positioning accuracy information.

Furthermore, the position information may be information indicating a region in which the communication device 110 is located. For example, information indicating a region determined by the government, such as a postal code or an address, may be used. Furthermore, for example, the region may be indicated by a set of three or more geographic coordinates. These pieces of information indicating the region may be provided together with the coordinate information.

Furthermore, in a case where the communication device 110 is located indoors, information indicating the floor of a building where the communication device 110 is located can also be included in the position information. For example, an identifier indicating the number of floors, the ground, or the underground, or the like can be included in the position information. Furthermore, for example, information indicating a further closed space inside a building, such as a room number and a room name in the building, can be included in the position information.

Typically, the positioning function is desirably included in the communication device 110. However, there may be cases where performance of the positioning function does not satisfy the required accuracy. Furthermore, even if the performance of the positioning function satisfies the required accuracy, there may be a case where it is not always possible to acquire the position information that satisfies the required accuracy depending on an installation position of the communication device 110. Therefore, a device different from the communication device 110 may include the positioning function, and the communication device 110 may acquire information related to the position from the device. The device having the positioning function may be an available existing device, or may be provided by the installer of the communication device 110. In such a case, it is desirable that the position information measured by the installer of the communication device 110 is written in the communication device 110.

The antenna information is typically information indicating performance, a configuration, and the like of an antenna included in the communication device 110. Typically, for example, information such as an antenna installation height, a tilt angle (downtilt), a horizontal orientation (azimuth), a boresight, an antenna peak gain, and an antenna model can be included.

Furthermore, the antenna information can also include information regarding a formable beam. For example, information such as a beam width, a beam pattern, and an analog or digital beamforming capability can be included.

Furthermore, the antenna information can also include information regarding performance and configuration of multiple input multiple output (MIMO) communication. For example, information such as the number of antenna elements and the maximum number of spatial streams (or the number of MIMO layers) can be included. Furthermore, codebook information to be used, weight matrix information, and the like can also be included. The weight matrix information includes a unitary matrix, a zero-forcing (ZF) matrix, a minimum mean square error (MMSE) matrix, and the like, which are obtained by singular value decomposition (SVD), eigen value decomposition (EVD), block diagonalization (BD), and the like. Furthermore, in a case where the communication device 110 includes a function such as maximum likelihood detection (MLD) that requires nonlinear calculation, information indicating the included function may be included in the antenna information.

Furthermore, the antenna information may include a zenith of direction, departure (ZoD). The ZoD is a type of radio wave arrival angle. Note that instead of being provided in notification from the communication device 110, the ZoD may be estimated and provided in notification by another communication device 110 from radio waves radiated from the antenna of the communication device 110. In this case, the communication device 110 may be a device that operates as a base station or an access point, a device that performs D2D communication, a moving relay base station, or the like. The ZoD may be estimated by a radio wave direction of arrival estimation technology such as multiple signal classification (MUSIC) or estimation of signal propagation via rotation invariance techniques (ESPRIT). Furthermore, the ZoD can be used by the communication control device 130 as measurement information.

The wireless interface information is typically information indicating a wireless interface technology included in the communication device 110. For example, identifier information indicating a technology used in GSM, CDMA2000, UMTS, E-UTRA, E-UTRA NB-IoT, 5G NR, 5G NR NB-IoT or a further next generation cellular system can be included as the wireless interface information. Furthermore, identifier information indicating a derivative technology based on Long Term Evolution (LTE)/5G such as MulteFire, Long Term Evolution-Unlicensed (LTE-U), or NR-Unlicensed (NR-U) can be included. Furthermore, identifier information indicating a standard technology such as a metropolitan area network (MAN) such as WiMAX or WiMAX2+ or a wireless LAN of the IEEE 802.11 series can also be included. Furthermore, identifier information indicating an extended global platform (XGP) or a shared XGP (sXGP) may be used. It may be identifier information of a communications technology for local power, wide area (LPWA). Furthermore, identifier information indicating a proprietary wireless technology can also be included. Furthermore, a version number or a release number of the technical specification that defines these technologies may also be included as the wireless interface information.

Furthermore, the wireless interface information can also include frequency band information supported by the communication device 110. For example, the frequency band information can be represented by an upper limit frequency, a lower limit frequency, a center frequency, a bandwidth, a 3GPP operating band number, or a combination of at least two of these, or the like. Furthermore, one or more pieces of frequency band information can be included in the wireless interface information.

The frequency band information supported by the communication device 110 can further include information indicating capability of a band extension technology such as carrier aggregation (CA) or channel bonding. For example, combinable band information or the like can be included. Furthermore, the carrier aggregation can also include information regarding a band desired to be used as a primary component carrier (PCC) or a secondary component carrier (SCC). Furthermore, the number of component carriers (the number of CCs) that can be aggregated at the same time can be included.

The frequency band information supported by the communication device 110 may further include information indicating a combination of frequency bands supported by the dual connectivity and the multi connectivity. Furthermore, information of another communication device 110 that cooperatively provides the dual connectivity and the multi connectivity may also be provided. The communication control device 130 may perform determination of the communication control disclosed in the present embodiment in consideration of another communication device 110 having a cooperative relationship or the like in subsequent procedures.

The frequency band information supported by the communication device 110 may also include information indicating radio wave usage priority such as PAL and GAA.

Furthermore, the wireless interface information can also include modulation scheme information supported by the communication device 110. For example, as a representative example, information indicating a primary modulation scheme such as frequency shift keying (FSK), n-value phase shift keying (PSK, where n is a multiplier of two, such as two, four, eight, or the like), and n-value quadrature amplitude modulation (QAM, where n is a multiplier of four, such as four, sixteen, 64, 256, 1024) can be included. Furthermore, information indicating a secondary modulation scheme such as orthogonal frequency division multiplexing (OFDM), scalable OFDM, DFT spread OFDM (DFT-s-OFDM), generalized frequency division multiplexing (GFDM), and filter bank multi carrier (FBMC) can be included.

Furthermore, the wireless interface information can also include information regarding an error correction code. For example, capabilities of a turbo code, a low density parity check (LDPC) code, a polar code, an erasure correction code, and the like, and coding rate information to be applied can be included.

The modulation scheme information and the information regarding the error correction code can also be expressed by a modulation and coding scheme (MCS) index as another aspect.

Furthermore, the wireless interface information can also include information indicating a function specific to each wireless technical specification supported by the communication device 110. For example, as a representative example, there is transmission mode (TM) information defined in LTE. Furthermore, those having two or more modes for a specific function can be included in the wireless interface information such as TM information. Furthermore, in the technical specification, in a case where the communication device 110 supports a function that is not essential in the specification even if there are not two or more modes, information indicating the supported function can also be included.

Furthermore, the wireless interface information can also include radio access technology (RAT) information supported by the communication device 110. For example, information indicating time division multiple access (TDMA), frequency division multiple access (FDMA), orthogonal frequency division multiple access (OFDMA), power division multiple access (PDMA), code division multiple access (CDMA), sparse code multiple access (SCMA), interleave division multiple access (IDMA), spatial division multiple access (SDMA), carrier sense multiple access/collision avoidance (CSMA/CA), carrier sense multiple access/collision detection (CSMA/CD), or the like can be included. Note that the TDMA, FDMA, and OFDMA are classified into orthogonal multiple access (OMA). The PDMA, CDMA, SCMA, IDMA, and SDMA are classified into non orthogonal multiple access (NOMA). A representative example of the PDMA is a technique implemented by a combination of superposition coding (SPC) and successive interference canceller (SIC). The CSMA/CA and CSMA/CD are classified into opportunistic access.

In a case where the wireless interface information includes information indicating the opportunistic access, information indicating details of the access method may be further included. As a specific example, information indicating which of frame based equipment (FBE) and load based equipment (LBE) defined in EN 301 598 of ETSI may be included.

In a case where the radio interface information indicates the LBE, the wireless interface information may further include LBE-specific information such as a priority class.

Furthermore, the wireless interface information can also include information regarding a duplex mode supported by the communication device 110. As a representative example, information regarding a method such as frequency division duplex (FDD), time division duplex (TDD), or full duplex (FD) can be included for example.

In a case where TDD is included as the wireless interface information, TDD frame structure information used or supported by the communication device 110 can be given. Furthermore, information related to the duplex mode may be included for each frequency band indicated by the frequency band information.

In a case where the FD is included as the wireless interface information, information regarding an interference power detection level may be included.

Furthermore, the wireless interface information can also include information regarding a transmission diversity method supported by the communication device 110. For example, space time coding (STC) or the like may be included.

Furthermore, the wireless interface information can also include guard band information. For example, information regarding a predetermined guard band size in the wireless interface can be included. Alternatively, for example, information regarding a guard band size desired by the communication device 110 may be included.

Regardless of the aspects described above, the wireless interface information may be provided for each frequency band.

The legal information is typically information regarding regulations that the communication device 110 has to comply with and defined by the radio administration agency or an equivalent agency in each country or region, authentication information acquired by the communication device 110, or the like. Typically, the information regarding the regulations can include, for example, upper limit value information of out-of-band emission, information regarding a blocking characteristic of the receiver, and the like. Typically, the authentication information can include, for example, type approval information, legal regulation information serving as an authentication acquisition criterion, and the like. The type approval information corresponds to, for example, FCC ID in the United States, the technical standards conformity certification in Japan, and the like. The legal regulation information corresponds to, for example, FCC rule numbers in the United States, ETSI Harmonized Standard number in Europe, and the like.

Among the legal information, regarding numerical values, those defined in the standard specification of wireless interface technology may be substituted. The standard specification of the wireless interface technology corresponds to, for example, 3GPP TS36.104, TS38.104, or the like. An adjacent channel leakage ratio (ACLR) is defined therein. Instead of the upper limit value information of the out-of-band emission, the upper limit of the out-of-band emission may be derived and used using the ACLR defined in the standard specification. Furthermore, the ACLR itself may be used as necessary. Furthermore, adjacent channel selectivity (ACS) may be used instead of the blocking characteristic. Furthermore, these may be used in combination, or an adjacent channel interference ratio (ACIR) may be used. Note that, in general, the ACIR has the following relationship with the ACLR and ACS.

$$\begin{matrix}[ Math . 1 ] & \\ ACIR = {( \frac{1}{ACS} + \frac{1}{ACLR} )}^{- 1} & ( 1 )\end{matrix}$$

Note that although Expression (1) uses true value expression, Expression (1) may be expressed by logarithmic expression.

The installer information can include information capable of specifying a person who installs the communication device 110 (installer), unique information linked with the installer, and the like. Typically, the installer information can include information regarding a person who is responsible for the position information of the communication device 110, such as a certified professional installer (CPI) defined in Non-Patent Document 1. The CPI discloses certified professional installer registration ID (CPIR-ID) and CPI name. Furthermore, as unique information linked with the CPI, for example, a contact address (mailing address or contact address), an e-mail address, a telephone number, a public key identifier (PKI), and the like are disclosed. It is not limited thereto, and other information related to the installer may be included in the installer information as necessary.

The group information can include information regarding the communication device group to which the communication device 110 belongs. Specifically, for example, information related to the same or equivalent type of group as disclosed in WINNF-SSC-0010 can be included. Furthermore, for example, in a case where the communication operator manages the communication devices 110 in units of groups according to its own operation policy, information regarding the groups can be included in the group information.

The information listed so far may be estimated by the communication control device 130 from other information provided from the communication device 110 without the communication device 110 providing the information to the communication control device 130. Specifically, for example, the guard band information can be estimated from the wireless interface information. In a case where the wireless interface used by the communication device 110 is E-UTRA or 5G NR, it can be estimated on the basis of the transmission bandwidth specification of E-UTRA described in 3GPP TS36.104, the transmission bandwidth specification of 5G NR described in 3GPP TS38.104, and tables described in TS38.104 illustrated below.

TABLE 1
Table 5.6-1 Transmission bandwidth configuration NRB in E-UTRA
channel bandwidths (Cited from Table 5.6-1 in 3GPP TS 36.104)

| | | | | | | |
|---|---|---|---|---|---|---|
| Channel bandwidth | 1.4 | 3 | 5 | 10 | 15 | 20 |
| BW_{Channel}: [MHz] | | | | | | |
| Transmission | 6 | 15 | 25 | 50 | 75 | 100 |
| bandwidth | | | | | | |
| configuration N_{RB} | | | | | | |

TABLE 2
Table 5.3.3-1 Minimum guardband (kHz) (FR1) (Cited from Table 5.3.3-1 in 3GPP TS 38.104)

| SCS | 5 | 10 | 15 | 20 | 25 | 30 | 40 | 50 | 60 | 70 | 80 | 90 | 100 |
|---|---|---|---|---|---|---|---|---|---|---|---|---|---|
| (kHz) | MHz | MHZ | MHZ | MHZ | MHZ | MHZ | MHZ | MHZ | MHz | MHz | MHZ | MHZ | MHz |
| 15 | 242. 5 | 312. 5 | 382. 5 | 452. 5 | 522.5 | 592. 5 | 552.5 | 692. 5 | N. A | N. A | N. A | N. A | N. A |
| 30 | 505 | 665 | 645 | 805 | 785 | 945 | 905 | 1045 | 825 | 965 | 925 | 885 | 845 |
| 60 | N. A | 1010 | 990 | 1330 | 1310 | 1290 | 1610 | 1570 | 1530 | 1490 | 1450 | 1410 | 1370 |

TABLE 3
Table 5.3.3-2 Minimum guardband (kHz) (FR2)
(Cited from Table 5.3.3-2 in 3GPP TS 38.104)

| SCS (kHz) | 50 MHz | 100 MHz | 200 MHz | 400 MHz |
|---|---|---|---|---|
| 60 | 1210 | 2450 | 4930 | N.A |
| 120 | 1900 | 2420 | 4900 | 9860 |

TABLE 4
Table 5.3.3-3 Minimum guardband (kHz) of SCS 240 kHz SS/PBCH
block (FR2) (Cited from Table 5.3.3-3 in 3GPP TS 38.104)

| SCS (kHz) | 100 MHz | 200 MHz | 400 MHz |
|---|---|---|---|
| 240 | 3800 | 7720 | 15560 |

In other words, it is sufficient that the communication control device 130 can acquire the information listed so far, and the communication device 110 is not necessarily required to provide the information to the communication control device 130. Furthermore, the intermediate device 130B (for example, a network manager) that bundles the plurality of communication devices 110 does not need to provide the information to the communication control device 130A. Providing information by the communication device 110 or the intermediate device 130B to the communication control device 130 or 130A is merely one means of information provision in the present embodiment. The information listed so far means information that can be necessary for the communication control device 130 to normally complete this procedure, and means for providing the information does not matter. For example, in WINNF-TS-0061, such a method is called multi-step registration and allowed.

Furthermore, as a matter of course, the information listed so far is selectively applicable depending on the local legal system and technical specifications.

### <2.1.1.1 Supplement of Required Parameters>

In the registration procedure, in some cases, it is assumed that the device parameters related to not only the communication device 110 but also the terminal 120 are required to be registered in the communication control device 130. In such cases, the term “communication device” in the description given in <2.1.1> may be replaced with a term “terminal” or a similar term. Furthermore, parameters specific to “terminal”, not described in <2.1.1>, may also be treated as required parameters in the registration procedure. For example, there is a user equipment (UE) category defined in 3GPP, and the like.

### <2.1.2 Details of Registration Process>

As described above, the communication device 110 representing the wireless system that intends to use the frequency band generates a registration request including the device parameter and notifies the communication control device 130 of the registration request.

Here, in a case where the installer information is included in the device parameters, the communication device 110 may perform a tamper-proof process or the like on the registration request by using the installer information. Furthermore, a part or all of the information included in the registration request may be subjected to an encryption process. Specifically, for example, a unique public key may be shared in advance between the communication device 110 and the communication control device 130, and the communication device 110 may encrypt information using a secret key corresponding to the public key. Examples of the encryption target include security sensitive information such as position information.

Note that there may be cases where the ID and the position information of the communication device 110 are disclosed, and the communication control device 130 holds in advance the ID and the position information of the main communication device 110 existing in its coverage. In such a case, since the communication control device 130 can acquire the position information from the ID of the communication device 110 that has transmitted the registration request, the position information does not need to be included in the registration request. Furthermore, it is also conceivable that the communication control device 130 returns necessary device parameters to the communication device 110 that has transmitted the registration request, and in response to this, the communication device 110 transmits a registration request including the device parameters necessary for registration. In this manner, the information included in the registration request may be different depending on the case.

After receiving the registration request, the communication control device 130 performs a registration process of the communication device 110 and returns a registration response according to a processing result. If there is no shortage or abnormality of information necessary for registration, the communication control device 130 records the information in an internal or external storage device and provides notification of normal completion. Otherwise, notification of a registration failure is provided. In a case where the registration is normally completed, the communication control device 130 may allocate an ID to each of the communication devices 110 and provide notification of such ID information at the time of response. In a case where the registration fails, the communication device 110 may provide notification of a revised registration request again. Furthermore, the communication device 110 may change the registration request and try the registration procedure until the normal completion.

Note that the registration procedure is sometimes executed even after the registration is normally completed. Specifically, for example, the registration procedure can be re-executed in a case where the position information is changed beyond a predetermined criterion due to movement, accuracy improvement, or the like. The predetermined criterion is typically determined by the legal system in each country or region. For example, in 47 C.F.R. Part 15 in the United States, a Mode II personal/portable white space device, that is, a device using a free spectrum is required to perform registration again in a case where its position changes by 100 meters or more.

### <2.2 Available Spectrum Information Query Procedure (Available Spectrum Query Procedure)>

The available spectrum information query procedure is a procedure in which a wireless system that intends to use a frequency band inquires of the communication control device 130 for information regarding an available spectrum. Note that the available spectrum information query procedure does not necessarily need to be performed. Furthermore, the communication device 110 that makes an inquiry on behalf of the wireless system that intends to use the frequency band may be the same as or different from the communication device 110 that has generated the registration request. Typically, the communication device 110 that makes an inquiry notifies the communication control device 130 of a query request including information that can specify the communication device 110, and thereby the procedure is started.

Here, typically, the available spectrum information is information indicating a spectrum in which the communication device 110 can safely perform secondary use without giving fatal interference to the primary system.

The available spectrum information is determined, for example, on the basis of a secondary use prohibited area called an exclusion zone. Specifically, for example, in a case where the communication device 110 is installed in the secondary use prohibited area provided for the purpose of protecting the primary system using a frequency channel F1, the communication device 110 is not notified of the frequency channel F1 as an available channel.

The available spectrum information can also be determined, for example, by the degree of interference to the primary system. Specifically, for example, in a case where it is determined that fatal interference is given to the primary system even outside the secondary use prohibited area, such a frequency channel is not provided in notification as an available channel in some cases. An example of a specific calculation method is described in <2.2.2> described later.

Furthermore, as described above, there may be frequency channels that are not notified as available due to conditions other than primary system protection requirements. Specifically, for example, in order to avoid interference that may occur between the communication devices 110 in advance, there may be cases where a frequency channel being used by another communication device 110 existing in the vicinity of the communication device 110 is not notified as an available channel. In this manner, the available spectrum information set in consideration of interference with the other communication device 110 may be set as, for example, “use recommended spectrum information” and provided together with the available spectrum information. That is, the “use recommended spectrum information” is desirably a subset of the available spectrum information.

Even in a case of affecting the primary system, if the influence can be avoided by reducing the transmission power, the same spectrum as of the primary system or the communication device 110 in the vicinity may be notified as an available channel. In such a case, typically, maximum allowable transmission power information is included in the available spectrum information. The maximum allowable transmission power is typically expressed by EIRP. The maximum allowable transmission power is not necessarily limited thereto, and may be provided by, for example, a combination of conducted power and an antenna gain. Moreover, the antenna gain may be set to an allowable peak gain for each spatial direction.

### <2.2.1 Details of Required Parameters>

As the information that can specify the wireless system that intends to use the frequency band, for example, unique information registered at the time of the registration procedure, the above-described ID information, and the like can be assumed.

Furthermore, the query request can also include query requirement information. The query requirement information can include, for example, information indicating a frequency band for which it is desired to know whether or not it is available. Furthermore, for example, the transmission power information can be included. The communication device 110 that makes an inquiry can include the transmission power information, for example, in a case where it is desired to know only spectrum information in which it is likely that desired transmission power can be used. The query requirement information does not necessarily need to be included in the query request.

The information indicating the frequency band may also include information indicating a format of the available spectrum information. In the IEEE 802.11 standard, a channel number is defined for each band. For example, a flag for requesting availability of a channel defined in such wireless interface technical specifications may be included. As another form, a flag for requesting availability of a unit spectrum range instead of the defined channel may be included. In a case where the unit spectrum is 1 MHz, the available spectrum information is requested for each spectrum range of 1 MHz. In a case where this flag is used, the desired unit spectrum information may be enclosed in the flag.

Furthermore, the query request can also include a measurement report. The measurement report includes results of measurement performed by the communication device 110 and/or the terminal 120. Some or all of the measurement results may be represented by raw data or may be represented by processed data. For example, standardized metrics represented by reference signal received power (RSRP), reference signal strength indicator (RSSI), and reference signal received quality (RSRQ) can be used for measurement.

### <2.2.2 Details of Available Spectrum Evaluation Process>

After receiving the query request, the available spectrum is evaluated on the basis of the query requirement information. For example, as described above, the available spectrum can be evaluated in consideration of existence of the primary system, the secondary use prohibited area thereof, and the communication device 110 in the vicinity.

The communication control device may derive the secondary use prohibited area. For example, in a case where the maximum transmission power P_{MaxTx(dBm)} and the minimum transmission power P_{MinTx(dBm)} are defined, it is possible to calculate the range of the separation distance between the primary system and the secondary system from the following expression and determine the secondary use prohibited area.

$$\begin{matrix}[ Math . 2 ] & \\ {{PL}^{- 1} ( {P}_{MaxTx ( dBm )} - {I}_{Th ( dBm )} )}_{( dB )} \leq d < {{PL}^{- 1} ( {P}_{MinTx ( dBm )} - {I}_{Th ( dBm )} )}_{( dB )} & \end{matrix}$$

I_{Th(dBm)} is allowable interference power (a limit value of allowable interference power), d is a distance between a predetermined reference point and the communication device 110, and PL( )_{(dB)} is a function of a propagation loss. Therefore, the spectrum availability can be determined according to the positional relationship between the primary system and the communication device 110. Furthermore, in a case where transmission power information or power range information desired to be used by the communication device 110 is supplied in a request, the spectrum availability can be determined by calculating PL⁻¹(P_{Tx(dBm}−I_{Th(dBm)}) and performing a comparison with the above-described range expression.

The maximum allowable transmission power information may be derived. Typically, the maximum allowable transmission power information is calculated by using allowable interference power information in the primary system or a protection zone thereof, position information of the reference point for calculating an interference power level suffered by the primary system, registration information of the communication device 110, and a propagation loss estimation model. Specifically, as an example, it is calculated by the following mathematical expression.

$$\begin{matrix}[ Math . 3 ] & \\ {P}_{MaxTx ( dBm )} = {I}_{Th ( dBm )} + {PL ( d )}_{( dB )} & ( 3 )\end{matrix}$$

In Expression (2), the antenna gain in a transceiver is not included, but the antenna gain in the transceiver may be included according to the maximum allowable transmission power expression method (EIRP, conducted power, and the like) or the reception power reference point (antenna input point, antenna output point, and the like). Furthermore, a safety margin or the like for compensating for variation due to fading may be included. Furthermore, a feeder loss may be considered as necessary. Furthermore, it is possible to similarly perform calculation for an adjacent channel by adding the adjacent channel leakage ratio (ACRL) or an out-of-band emission maximum value.

Furthermore, Expression (2) is described on the basis of the assumption that the single communication device 110 is an interference source (single station interference). For example, in a case where it is necessary to consider aggregated interference from a plurality of communication devices 110 at the same time, a correction value may be added. Specifically, for example, the correction value can be determined on the basis of three types (fixed/predetermined, flexible, flexible minimized) of interference margin distribution methods disclosed in Non-Patent Document 6 (ECC Report 186).

Note that the allowable interference power information itself is not necessarily directly available as in Expression (2). For example, in a case where a required signal power-to-interference power ratio (SIR) of the primary system, a signal to interference plus noise ratio (SINR), and the like are available, they may be converted into allowable interference power and used. Note that such a conversion process is not limited to this process, and may be applied to process of other procedures.

Note that Expression 2 is expressed using logarithms, but as a matter of course, may be used by being converted into antilogarithms at the time of implementation. Furthermore, all parameters in logarithmic notation described in the present disclosure may be used by being appropriately converted into antilogarithms.

Furthermore, in a case where the above-described transmission power information is included in the query requirement information, the available spectrum can be evaluated by a method different from the above-described method. Specifically, for example, in a case where it is assumed that desired transmission power indicated by transmission power information is used, when an estimated interference quantity is less than allowable interference power in the primary system or a protection zone thereof, it is determined that the frequency channel is available, and the communication device 110 is notified of the frequency channel.

Furthermore, for example, in a case where an area or a space in which the communication device 110 can use the frequency band is determined in advance similarly to an area of a radio environment map (REM), the available spectrum information may be simply derived on the basis of only coordinates (coordinates or latitude, longitude, and ground level of the X axis, the Y axis, and the Z axis of the communication device 110) included in the position information of the communication device 110. Furthermore, for example, even in a case where a lookup table that associates coordinates of a position of the communication device 110 with available spectrum information is prepared, the available spectrum information described above may be derived on the basis of only the position information of the communication device 110. As described above, there are various methods for the method of determining the available spectrum, and it is not limited to the example of the present disclosure.

Furthermore, in a case where the communication control device 130 acquires information regarding capability of a band extension technology such as carrier aggregation (CA) or channel bonding as the frequency band information supported by the communication device 110, the communication control device 130 may include an available combination, a recommended combination, or the like thereof in the available spectrum information.

Furthermore, in a case where the communication control device 130 acquires information regarding a combination of frequency bands supported by the dual connectivity and the multi connectivity as the frequency band information supported by the communication device 110, the communication control device 130 may include information such as an available spectrum and a recommended spectrum in the available spectrum information for the dual connectivity and the multi connectivity.

Furthermore, in a case of providing the available spectrum information for the band extension technology as described above, when the imbalance of the maximum allowable transmission power occurs between the plurality of frequency channels, the available spectrum information may be provided after adjusting the maximum allowable transmission power of each frequency channel. For example, from a perspective of primary system protection, the maximum allowable transmission power of each frequency channel may be aligned with the maximum allowable transmission power of a frequency channel having a low maximum allowable power flux density (power spectral density (PSD)).

The evaluation of the available spectrum does not necessarily need to be performed after the query request is received. For example, after normal completion of the above-described registration procedure, the communication control device 130 may independently perform the procedure without a query request. In such a case, an REM, a lookup table, or an information table similar to those described above as an example may be created.

Furthermore, the radio wave usage priority such as PAL or GAA may also be evaluated. For example, in a case where the registered device parameter or the query requirement includes information regarding the priority of radio wave use, it may be determined whether spectrum use is possible on the basis of the priority, and the notification may be made. Furthermore, for example, as disclosed in Non-Patent Document 1, in a case where information (in Non-Patent Document 1, it is referred to as a cluster list) regarding the communication device 110 that performs high priority use (for example, PAL) from the user is registered in the communication control device 130 in advance, evaluation may be performed on the basis of the information.

After the evaluation of the available spectrum is completed, the communication control device 130 notifies the communication device 110 of the evaluation result.

The communication device 110 may select a desired communication parameter by using the evaluation result received from the communication control device 130. In a case where a spectrum grant procedure (to be described later) is not employed, the communication device 110 may start radio wave transmission using the selected desired communication parameter as a communication parameter.

### <2.3 Spectrum Grant Procedure>

The spectrum grant procedure is a procedure for the wireless system that intends to use the frequency band to receive the secondary use permission of the spectrum from the communication control device 130. The communication device 110 that performs the spectrum grant procedure as a representative of the wireless system may be the same as or different from the communication device 110 that has performed the procedures so far. Typically, the communication device 110 notifies the communication control device 130 of a spectrum grant request including information that can specify the communication device 110, thereby starting the procedure. Note that, as described above, the available spectrum information query procedure is not essential. Therefore, the spectrum grant procedure may be performed next to the available spectrum information query procedure, or may be performed next to a registration procedure.

In the present embodiment, it is assumed that at least the following two types of spectrum grant request methods can be used.
Designation scheme
Flexible scheme

The designation scheme is a request method in which the communication device 110 designates a desired communication parameter and requests the communication control device 130 to permit operation based on the desired communication parameter. Examples of the desired communication parameter include, but are not particularly limited to, a frequency channel to be used, a maximum transmission power, and the like. For example, a wireless interface technology specific parameter (such as a modulation scheme or a duplex mode) may be designated. Furthermore, information indicating radio wave usage priority such as PAL and GAA may be included.

The flexible scheme is a request method in which the communication device 110 designates only a requirement regarding a communication parameter and requests the communication control device 130 to designate a communication parameter that can be permitted for secondary use while satisfying the requirement. Examples of the requirement related to the communication parameter include, but are not particularly limited to, for example, a bandwidth, a desired maximum transmission power, or a desired minimum transmission power, and the like. For example, a wireless interface technology specific parameter (such as a modulation scheme or a duplex mode) may be designated. Specifically, for example, one or more TDD frame structures may be selected in advance and provided in notification.

Similarly to the query request, the spectrum grant request may also include the measurement report in either the designation scheme or the flexible scheme. The measurement report includes results of measurement performed by the communication device 110 and/or the terminal 120. The measurement may be represented by raw data or processed data. For example, standardized metrics represented by reference signal received power (RSRP), reference signal strength indicator (RSSI), and reference signal received quality (RSRQ) can be used for measurement.

Note that the scheme information used by the communication device 110 may be registered in the communication control device 130 at the time of the registration procedure described in <2.1>.

### <2.3.1 Details of Spectrum Grant Process>

After receiving the spectrum grant request, the communication control device 130 performs spectrum grant process on the basis of the spectrum grant request scheme. For example, using the technique described in <2.2>, it is possible to perform the spectrum grant process in consideration of the primary system, the secondary use prohibited area, the existence of the communication device 110 in the vicinity, and the like.

In a case where the flexible scheme is used, the maximum allowable transmission power information may be derived using the method described in <2.2.2>. Typically, the maximum allowable transmission power information is calculated by using allowable interference power information in the primary system or a protection zone thereof, position information of the reference point for calculating an interference power level suffered by the primary system, registration information of the communication device 110, and a propagation loss estimation model. Specifically, as an example, it is calculated by Expression (2) described above.

Furthermore, as described above, Expression (2) is described on the basis of the assumption that the single communication device 110 is an interference source. For example, in a case where it is necessary to consider aggregated interference from a plurality of communication devices 110 at the same time, a correction value may be added. Specifically, for example, the correction value can be determined on the basis of three types of methods (fixed/predetermined, flexible, flexible minimized) disclosed in Non-Patent Document 6 (ECC Report 186).

The communication control device 130 can use various propagation loss estimation models in the spectrum grant procedure, an available spectrum evaluation process for an available spectrum information query request, and the like. In a case where a model is designated for each application, it is desirable to use the designated model. For example, in Non-Patent Document 1 (WINNF-TS-0112), a propagation loss model such as Extended Hata (eHATA) or Irregular Terrain Model (ITM) is employed for each application. Of course, the propagation loss model is not limited thereto.

There are also propagation loss estimation models that require information regarding radio wave propagation paths. The information regarding the radio wave propagation path can include, for example, information indicating inside and outside of a line of sight (Line of Sight (LOS) and/or Non Line of Sight (NLOS)), topographical information (undulations, sea levels, and the like), environmental information (Urban, Suburban, Rural, Open Sky, and the like), and the like. When using the propagation loss estimation model, the communication control device 130 may estimate these pieces of information from the registration information of the communication device 110 or the information of the primary system that is already acquired. Alternatively, in a case where there is a parameter designated in advance, it is desirable to use the parameter.

In a case where the propagation loss estimation model is not designated in a predetermined application, the propagation loss estimation model may be selectively used as necessary. For example, when estimating the interference power to the other communication device 110, a model that is calculated with a small loss such as a free space loss model is used, but when estimating the coverage of the communication device 110, a model that is calculated with a large loss can be used.

Furthermore, in a case where the designated propagation loss estimation model is used, as an example, the spectrum grant process can be performed by evaluating an interfering risk. Specifically, for example, in a case where it is assumed that desired transmission power indicated by transmission power information is used, when an estimated interference quantity is less than the allowable interference power in the primary system or a protection zone thereof, it is determined that use of the frequency channel can be permitted, and the communication device 110 is notified of the determination.

In any technique of the designation scheme and the flexible scheme, the radio wave usage priority such as PAL or GAA may also be evaluated similarly to the query request. For example, in a case where the registered device parameters or the query requirements include information regarding the radio wave usage priority, it may be determined whether or not it is possible to use a spectrum on the basis of the priority, and the notification may be made. Furthermore, for example, in a case where information regarding the communication device 110 that performs high priority use (for example, PAL) from the user is registered in the communication control device 130 in advance, evaluation may be performed on the basis of the information. For example, in Non-Patent Document 1 (WINNF-TS-0112), information regarding the communication device 110 is referred to as a cluster list.

Furthermore, in any calculation described above, the spectrum availability may be determined by performing correction of the position information or the coverage by using the positioning accuracy information (location uncertainty) when the position information of the communication device is used.

The spectrum grant process is not necessarily performed due to reception of the spectrum grant request. For example, after the normal completion of the above-described registration procedure, the communication control device 130 may independently perform the spectrum grant process without the spectrum grant request. Furthermore, for example, the spectrum grant process may be performed at regular intervals. In such a case, the above-described REM, a lookup table, or information tables similar thereto may be created. Thus, the spectrum that can be permitted is determined only by the position information, and thus the communication control device 130 can quickly return a response after receiving the spectrum grant request.

### <2.4 Spectrum Use Notification (Spectrum Use Notification/Heartbeat)>

The spectrum use notification is a procedure in which the wireless system using the frequency band notifies the communication control device 130 of the use of the spectrum based on the communication parameter allowed to be used in the spectrum grant procedure. The communication device 110 that performs the spectrum use notification as a representative of the wireless system may be the same as or different from the communication device 110 that has performed the procedures so far. Typically, the communication device 110 notifies the communication control device 130 of a notification message including information that can specify the communication device 110.

The spectrum use notification is desirably performed periodically until the use of the spectrum is rejected from the communication control device 130. In that case, the spectrum use notification is also referred to as a heartbeat.

After receiving the spectrum use notification, the communication control device 130 may determine whether to start or continue the spectrum use (in other words, radio wave transmission at the permitted spectrum). Examples of the determination method include confirmation of the spectrum use information of the primary system. Specifically, it is possible to determine permission or rejection of start or continuation of the spectrum use (radio wave transmission at the permitted spectrum) on the basis of a change in the use spectrum of the primary system, a change in a spectrum use situation of the primary system in which the use of radio waves is not steady (for example, a ship radar of CBRS in the United States), and the like. If the start or continuation is permitted, the communication device 110 may start or continue the spectrum use (radio wave transmission at the permitted spectrum).

After receiving the spectrum use notification, the communication control device 130 may command reconfiguration of communication parameters to the communication device 110. Typically, the reconfiguration of communication parameters can be commanded in a response of the communication control device 130 to the spectrum use notification. For example, information regarding recommended communication parameters (hereinafter, recommended communication parameter information) can be provided. The communication device 110 to which the recommended communication parameter information has been provided desirably performs the spectrum grant procedure described in <2.4> again using the recommended communication parameter information.

### <2.5 Supplement of Various Procedures>

The various procedures described above do not necessarily need to be implemented individually, as described below. For example, two different procedures may be implemented by substituting a third procedure having roles of the two different procedures.

Specifically, for example, the registration request and the available spectrum information query request may be integrally provided in notification. Furthermore, for example, the spectrum grant procedure and the spectrum use notification may be integrally performed. As a matter of course, it is not limited to these combinations, and three or more procedures may be performed integrally. Furthermore, as described above, one procedure may be separately performed a plurality of times.

Furthermore, the expression “acquisition” or an expression equivalent thereto in the present disclosure does not necessarily mean acquisition according to the procedure described in the present disclosure. For example, although it is described that the position information of the communication device 110 is used in the available spectrum evaluation process, the information acquired in the registration procedure does not necessarily need to be used, and in a case where position information is included in an available spectrum query procedure request, this position information may be used. In other words, the procedure for acquisition described in the present disclosure is an example, and acquisition by other procedures is also permitted within the scope of the present disclosure and within the scope of technical feasibility.

Furthermore, the information described to be included in the response from the communication control device 130 to the communication device 110 may be actively provided in notification from the communication control device 130 by a push scheme if possible. As a specific example, the available spectrum information, the recommended communication parameter information, a radio wave transmission continuation rejection notification, and the like may be provided in notification by the push scheme.

### <2.6 Various Procedures for Terminal>

So far, the description has been made mainly assuming the process in the communication device 110A. However, in some embodiments, not only the communication device 110A but also the terminal 120 and the communication device 110B can operate under management of the communication control device 130. That is, a scenario in which the communication parameters are determined by the communication control device 130 is assumed. Even in such a case, basically, the respective procedures described in <2.1> to <2.4> can be used. However, unlike the communication device 110A, the terminal 120 and the communication device 110B need to use the spectrum managed by the communication control device 130 for the backhaul link, and cannot perform radio wave transmission without permission. Therefore, it is desirable to start backhaul communication for the purpose of accessing the communication control device 130 only after detecting a radio wave or an authorization signal transmitted by the communication device 110A (communication device 110 capable of providing wireless communication service or the communication device 110 as a master in a master-secondary system).

On the other hand, under the management of the communication control device 130, there may be cases where, also in the terminal or the communication device 110B, an allowable communication parameter is set for the purpose of protecting the primary system. However, the communication control device 130 cannot know the position information and the like of these devices in advance. Furthermore, these devices are also likely to have mobility. That is, the position information is dynamically updated. Depending on the laws, in a case where the position information changes by a certain amount or more, re-registration to the communication control device 130 may be required in some cases.

In consideration of such various use forms, operation forms, and the like of the terminal 120 and the communication device 110, in the operation form of the TVWS (Non-Patent Document 7) defined by the Office of Communications (Ofcom), the following two types of communication parameters are defined.
Generic operational parameters
Specific operational parameters

The generic operational parameters are communication parameters defined as “parameters that can be used by any slave WSD located within the coverage area of a predetermined master WSD (corresponding to the communication device 110)” in Non-Patent Document 7. A feature is that it is calculated by a WSDB without using the position information of the slave WSD.

The generic operational parameters can be provided by unicast or broadcast from the communication device 110 that is already permitted to perform radio wave transmission from the communication control device 130. For example, a broadcast signal represented by a contact verification signal (CVS) defined in Part 15 Subpart H of the FCC rule in the United States can be used. Alternatively, it may be provided by a broadcast signal specific to a wireless interface. Therefore, the terminal 120 and the communication device 110B can use the generic operational parameters as the communication parameters used for radio wave transmission for the purpose of accessing the communication control device 130.

The specific operational parameters are communication parameters defined as “parameters that can be used by a specific slave white space device (WSD)” in Non-Patent Document 7. In other words, they are communication parameters calculated using device parameters of the slave WSD corresponding to the terminal 120. A feature is that it is calculated by a white space database (WSDB) using the position information of the slave WSD.

The CPE-CBSD Handshake Procedure defined in Non-Patent Document 5 can be regarded as another form of the procedure related to the terminal. The CPE-CBSD does not have a wired backhaul line and accesses the Internet via the BTS-CBSD. Therefore, permission for radio wave transmission in the CBRS band cannot be acquired from a SAS without a special regulation or procedure. The CPE-CBSD Handshake Procedure allows the CPE-CBSD to perform radio wave transmission at the same maximum EIRP and the minimum necessary duty cycle as those of a terminal (EUD) until permission for radio wave transmission is acquired from the SAS. Accordingly, the communication device 110B can construct a line for acquiring permission for radio wave transmission from the communication control device 130 by setting the transmission EIRP to the maximum EIRP of the terminal and then performing wireless communication with the communication device 110A at the minimum necessary duty cycle. After the permission for the radio wave transmission is acquired, it is possible to use up to the maximum EIRP defined by the communication device within the range of the permission.

### <2.7 Information Transmission Means>

A notification (signaling) between entities described so far can be implemented via various media. E-UTRA or 5G NR will be described as an example. As a matter of course, the present embodiment is not limited thereto at the time of implementation.

### <2.7.1 Signaling Between Communication Control Device 130 and Communication Device 110>

The notification from the communication device 110 to the communication control device 130 may be performed, for example, in an application layer. For example, the Hyper Text Transfer Protocol (HTTP) may be used. Signaling can be performed by describing required parameters in a message body of the HTTP according to a predetermined manner. Moreover, in a case where the HTTP is used, the notification from the communication control device 130 to the communication device 110 is also performed according to an HTTP response mechanism.

### <2.7.2 Signaling Between Communication Device 110 and Terminal 120>

The notification from the communication device 110 to the terminal 120 may be performed using, for example, at least one of radio resource control (RRC) signaling, system information (SI), or downlink control information (DCI). Furthermore, examples of a downlink physical channel include a physical downlink control channel (PDCCH), a physical downlink shared channel (PDSCH), a physical broadcast channel (PBCH), an NR-PDCCH, an NR-PDSCH, an NR-PBCH, and the like, but the downlink physical channel may be implemented using at least one of these.

The notification from the terminal 120 to the communication device 110 may be performed using, for example, radio resource control (RRC) signaling or uplink control information (UCI). Furthermore, it may be implemented by using an uplink physical channel (physical uplink control channel (PUCCH), physical uplink shared channel (PUSCH), physical random access channel (PRACH)).

The signaling is not limited to the above-described physical layer signaling, and the signaling may be performed at a higher layer. For example, at the time of implementation at the application layer, the signaling may be implemented by describing a required parameter in a message body of the HTTP according to a predetermined manner.

### <2.7.3 Signaling Between Terminals 120>

FIG. 6 illustrates an example of a flow of signaling in a case where device-to-device (D2D) or vehicle-to-everything (V2X), which is communication between the terminals 120, is assumed as communication of the secondary system. The D2D or V2X which is communication between the terminals 120 may be performed using a physical sidelink channel (a physical sidelink control channel (PSCCH), a physical sidelink shared channel (PSSCH), or a physical sidelink broadcast channel (PSBCH)). The communication control device 130 calculates a communication parameter to be used by the secondary system (T101) and notifies the communication device 110 of the secondary system of the calculated communication parameter (T102). A value of the communication parameter may be determined and provided in notification, or a condition indicating a range or the like of the communication parameter may be determined and provided in notification. The communication device 110 acquires the communication parameter to be used by the secondary system (T103), and sets the communication parameter that needs to be used by the communication device 110 itself (T104). Then, the terminal 120 is notified of a communication parameter to be used by the terminal 120 subordinate to the communication device 110 (T105). Each of the terminals 120 subordinate to the communication device 110 acquires (T106) and sets (T107) the communication parameter to be used by the terminal 120. Then, communication with another terminal 120 of the secondary system is performed (T108).

A communication parameter in a case where a target frequency channel for spectrum sharing is used in the sidelink (direct communication between the terminals 120) may be provided in notification, acquired, or set in a form linked with a resource pool for the sidelink in the target frequency channel. The resource pool is a radio resource for a sidelink set by a specific frequency resource or time resource. Examples of the frequency resource include a resource block, a component carrier, and the like. The time resource includes, for example, a radio frame, a subframe, a slot, a mini-slot, and the like. In a case where the resource pool is set in a frequency channel to be subjected to the spectrum sharing, the resource pool is set in the terminal 120 by the communication device 110 on the basis of at least one of the RRC signaling, the system information, or the downlink control information. Then, a communication parameter to be applied in the resource pool and the sidelink is also set in the terminal 120 by the communication device 110 on the basis of at least one of the RRC signaling, the system information, or the downlink control information from the communication device 110 to the terminal 120. The notification of setting of the resource pool and the notification of the communication parameter to be used in the sidelink may be performed simultaneously or individually.

### 2. Embodiment of Present Invention

First, a technical background of the embodiment of the present disclosure will be described.

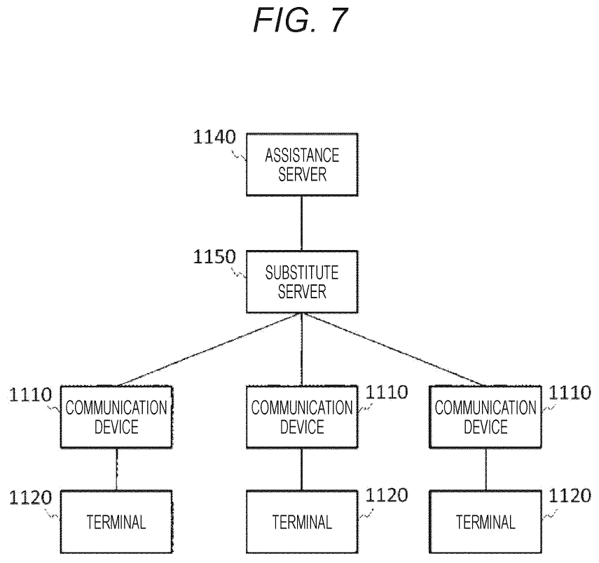

FIG. 7 illustrates an architecture of a communication system according to a related technology. FIG. 7 is an excerpt from the drawing of Patent Document 1, and reference numerals are newly given. The communication system includes a plurality of communication devices 1110 configured to execute wireless communication using a frequency in a specific frequency band, and an assistance server 1140 configured to record information regarding interference of the plurality of communication devices 1110 to a system to be protected in the specific frequency band. The communication device 1110 corresponds to a base station, and there is a terminal 1120 under the control of the communication device 1110. The communication device 1110 executes single interference estimation on the system to be protected before executing wireless communication to estimate interference of the wireless communication to the system to be protected, and executes wireless communication in a case where a sum of aggregate interference of the plurality of communication devices 1110 to the system to be protected before executing the single interference estimation indicated by the information and interference estimated by executing the single interference estimation does not exceed a limit value of interference to the system to be protected. As described as a problem of Patent Document 1, an object of this disclosure is to solve a concern of security and the like in information exchange that occurs in a case where the communication device 1110 side is provided with a function that has been a function performed by a spectrum management server. By applying this architecture, it is possible to protect the system to be protected without exchanging information between the communication devices 1110 having the function of the spectrum management server.

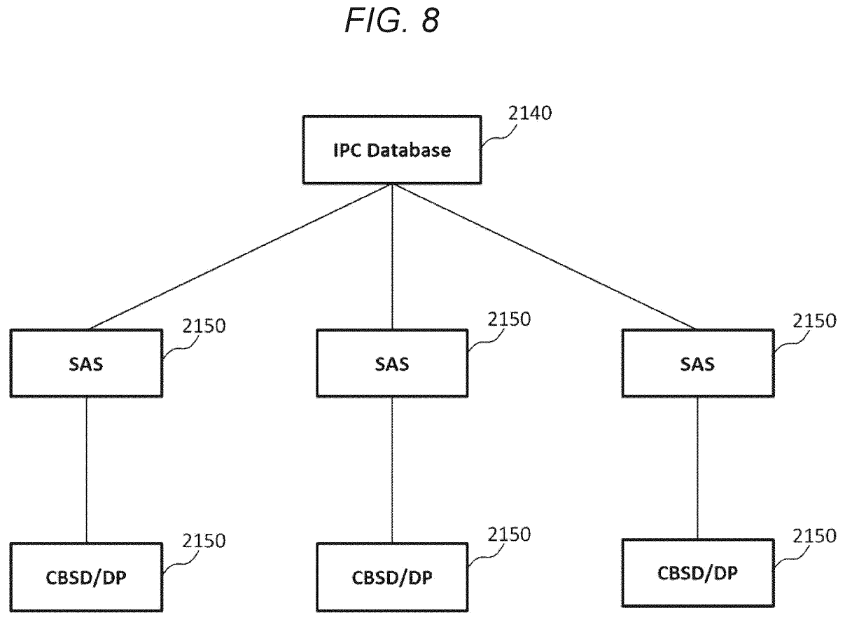

Furthermore, in this Patent Document 1, the function and process (single interference estimation, and the like) of the communication device described above may be substituted by a substitute server 1150. That is, as illustrated in FIG. 8, it is considered that the substitute server 1150 can be regarded as a spectrum management server 2150 such as the SAS of the CBRS, and the assistance server 1140 can be regarded as a common repository (IPC database) 2140 in which interference protection criteria (IPC) accessible from all the spectrum management servers are recorded. The communication device 1110 in FIG. 7 corresponds to a CBSD/DP 2150 of the CBRS. CBSD/DP refers to at least one of CBSD or DP. That is, if the architecture of the CBRS can be replaced with the architecture disclosed in Patent Document 1, it is theoretically possible to avoid the synchronization process such as the CPAS including information exchange between SASs.

However, the architecture disclosed in Patent Document 1 focuses on an unlicensed band, and does not consider a DSA vertical-oriented licensing system. In particular, sufficient study has not been conducted on a mechanism of base station registration management, use spectrum management, and aggregate interference protection in consideration of a license granting mechanism in units of “area in which base stations can be freely operated” unique to the vertical-oriented licensing system.

Therefore, the present disclosure provides a mechanism of base station registration management, use spectrum management, and aggregate interference protection in consideration of the license granting mechanism in units of “area in which base stations (communication devices) can be freely operated” unique to the vertical-oriented licensing system.

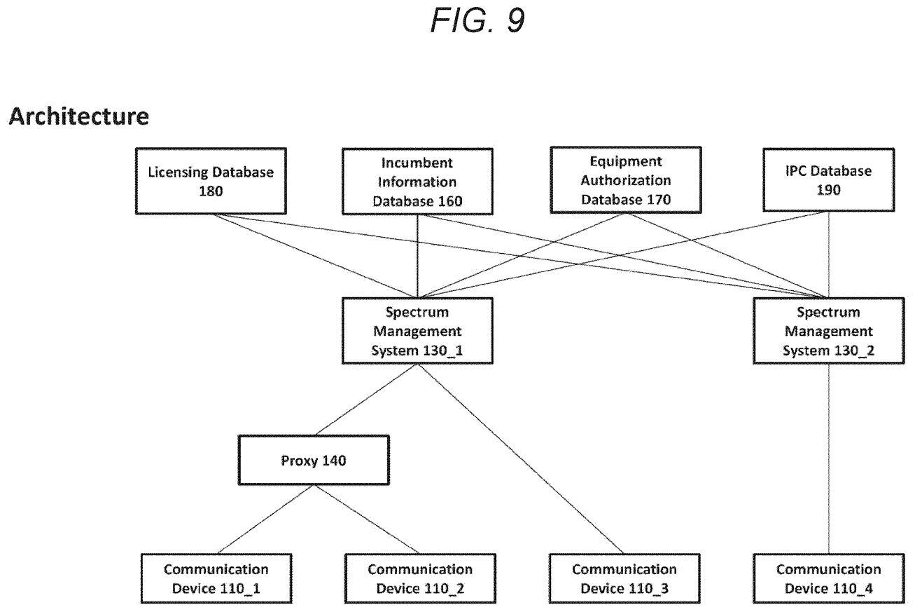

FIG. 9 is a diagram for describing an example of an architecture of a communication system according to the present embodiment.

Spectrum Management Systems 130_1 and 130_2 are entities corresponding to spectrum management servers. Hereinafter, the Spectrum Management Systems 130_1 and 130_2 will be referred to as spectrum management servers 130_1 and 130_2. The spectrum management servers 130_1 and 130_2 will be referred to as spectrum management servers 130 in a case where the spectrum management servers 130_1 and 130_2 are not particularly distinguished from each other.

Communication devices 110_1, 1102, 1103, and 110_4 are entities corresponding to base stations or access points. The communication device 110_1 to 110_4 will be referred to as communication devices 110 in a case where the communication device 110_1 to 110_4 are not particularly distinguished from each other.

A proxy 140 is an entity that accesses the spectrum management server 130 on behalf of one or more communication devices 110. In the illustrated example, the proxy 140 accesses the spectrum management server 130_1 on behalf of 110_1 and 110_2. Each of the communication devices 110_3 and 110_4 directly accesses the spectrum management server 130_2. As a similar entity, a domain proxy defined by the Wireless Innovation Forum for the CBRS in the United States is known.

A protection target information database (Incumbent Information Database) 160 is a database that stores information about an existing system (primary system) as a protection target in a target frequency band. The existing system is an example of a protection target entity. As similar entities, the Universal Licensing System (ULS) (https://www.fcc.gov/uls/transactions/daily-weekly) that the FCC in the United States imposes reference for the 6 GHz AFC System and the Spectrum Management System (SMS) (https://sms-sgs.ic.gc.ca/eic/site/sms-sgs-prod.nsf/eng/h_00010.html) that ISED Canada discloses for the white space and the 6 GHz band are known.

An equipment authorization database 170 is a database that stores equipment authorization information provided by a national regulatory authority (NRA) in a target country or region. As similar entities, the Equipment Authorization System (EAS) (https://apps.fcc.gov/oetcf/kdb/forms/FTSSearchResultPage.cfm?id=50070&switch=P) provided by the FCC in the United States and the Spectrum Management System (SMS) that ISED Canada discloses an authenticated device list for the white space and the 6 GHz band in a CSV file format (ISED discloses an authenticated device list and protection target system information on the same page) are known. In the present embodiment, it is assumed that the equipment authorization database 170 includes equipment authorization information of the communication device 110.

A licensing database 180 is a database that stores licensing information (license information) of users (a communication operator, a private network operator, and the like) who use the communication device 110. The licensing database 180 desirably stores at least the following information.

### Licensee Information (Licensing Data)

Licensee's name, ID, and the like
Valid period
License state
   Valid, expired, waived, or the like
License area information
   Area ID
   Information indicating shape
   License spectrum range (also referred to as frequency block or frequency band)
   Current number of communication devices (Optional)

### Order Information

Order of licensee for every license spectrum range (license area creation order)

An IPC database 190 is a database that records interference protection criteria (IPC) for every protection target entity in the target frequency band and a metric calculation value based on the interference protection criteria. For example, it is assumed that the IPC is aggregate interference power, and the protection target entity is a specific area. In this case, the area is sectioned into grids, for example, each grid point is used as a calculation reference point to calculate an aggregate interference power value, and the aggregate interference power value is recorded as a metric calculation value. Similarly, in a case where the protection target entity is a specific receiver, aggregate interference power calculated using the receiver as a calculation reference point is recorded as a metric calculation value.

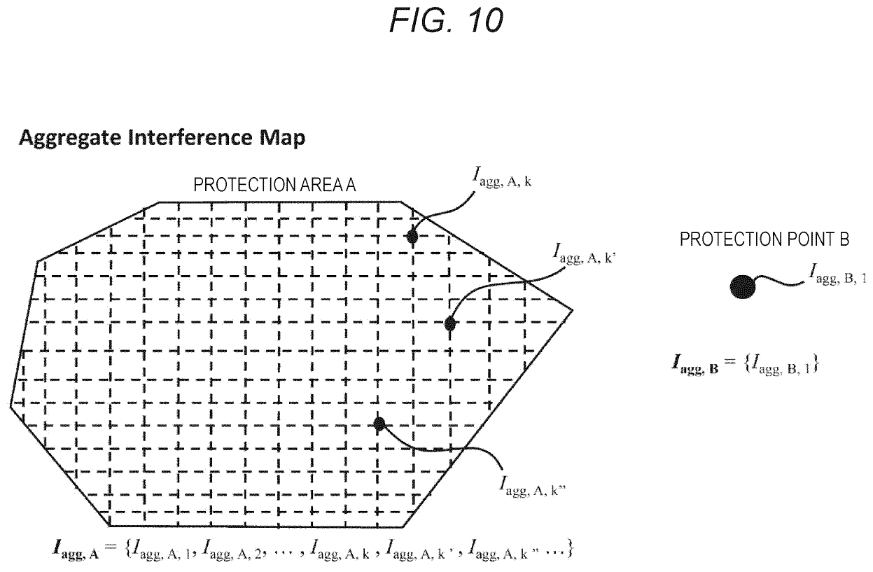

FIG. 10 is a diagram for describing an example of data recorded in the IPC database 190. The left figure illustrates an example in which the protection target entity is Protection area A, and the right figure illustrates an example in which the protection target entity is Protection point B. Protection area A is sectioned into grids as indicated by broken lines, and an aggregate interference power value of each grid point is stored as a metric value. Protection point B corresponds to, for example, a calculation reference point of the receiver, and an aggregate interference power value of the calculation reference point is stored as a metric value.

Both the spectrum management servers 130_1 and 130_2 can access the IPC database 190, and both the spectrum management servers 130_1 and 130_2 are given read/write authority.

Although the various databases 160 to 190 described above are configured as separate databases, all or some of the databases 160 to 190 may be integrally configured.

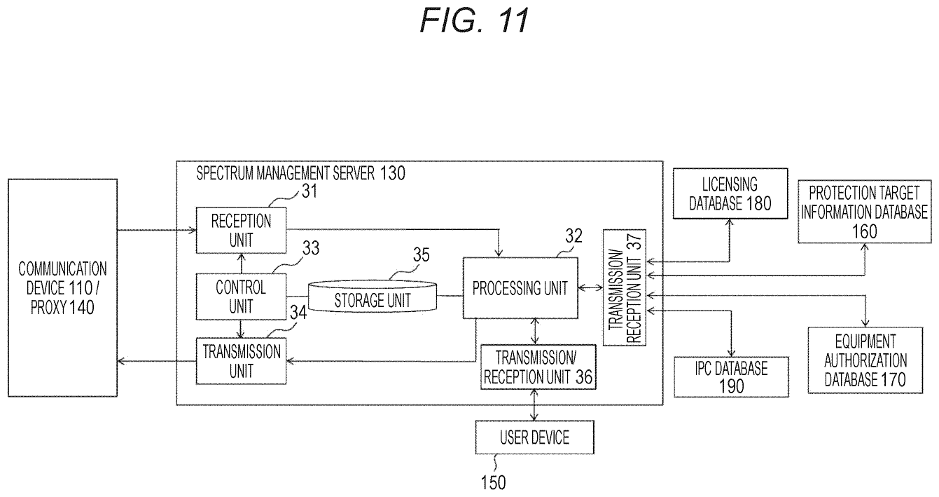

FIG. 11 is a block diagram illustrating an example of the spectrum management server 130 (130_1, 130_2). The spectrum management server 130 corresponds to a communication control device according to the present embodiment. The spectrum management server 130 includes a reception unit 31, a processing unit 32, a control unit 33, a transmission unit 34, a storage unit 35, a transmission/reception unit 36, and a transmission/reception unit 37.

The transmission unit 34 performs a process of transmitting a signal to the communication device 110 or the proxy 140 in a wireless or wired manner. The reception unit 31 performs a process of receiving a signal from the communication device 110 or the proxy 140 in a wireless or wired manner. The transmission unit 34 and the reception unit 31 each may include at least one antenna in a case where transmission and reception are performed wirelessly. The control unit 33 controls the reception process and the transmission process of the reception unit 31 and the transmission unit 34, and controls the entire spectrum management server 130.

The storage unit 35 stores, in advance, various types of information necessary for communication with the communication device 110, the proxy 140, and the various databases 160 to 190. As an example, the storage unit 35 stores information about the above-described registered user, the registered communication device 110, and the proxy 140. As the information about the communication device 110, the following may be stored: an ID of the communication device 110, position information, maximum transmission power information (EIRP capability value, maximum antenna power (maximum conducted power), and the like), dynamic beam pattern information (beam movable range information), information about antenna transmission power (conducted power), and the like. Furthermore, the storage unit 35 may store information about a spectrum grant (may be simply described as a grant) issued by the spectrum management server 130 to the communication device 110. The information about the spectrum grant may include, for example, an ID (grant ID) of the spectrum grant, a frequency permitted to be used by the communication device 110, allowable transmission power, a beam pattern, and the like.

The transmission/reception unit 36 communicates with a user device 150 operable by a user (operator or the like) of the communication device 110. The transmission/reception unit 36 includes a transmission unit that transmits information, data, or the like to the user device 150, and a reception unit that receives information, data, or the like from the user device 150. Communication between the transmission/reception unit 36 and the user device 150 may be wired or wireless. In a case of wireless communication, the transmission/reception unit 36 may include one or more antennas.

The processing unit 32 communicates with the user device 150 via the transmission/reception unit 36 to receive and execute various instructions from the user and execute a user registration process. As a means by which the user notifies the spectrum management server 130 of some information or message, for example, in a case of using a dedicated web portal or the like provided by an administrator of the spectrum management server 130, the user can perform various instructions by accessing the dedicated web portal or the like by using the user device 150 and performing an operation of giving a notification of the information or message.

The transmission/reception unit 37 communicates with various databases (the licensing database 180, the protection target information database 160, the equipment authorization database 170, and the IPC database 190). The transmission/reception unit 37 includes a transmission unit that transmits information, data, or the like to various databases, and a reception unit that receives information, data, or the like from these various databases. Communication between the transmission/reception unit 37 and these various databases may be wired or wireless. In a case of wireless communication, the transmission/reception unit 37 may include one or more antennas. Although the transmission/reception unit 37 is provided in common in various databases, the transmission/reception unit 37 may be configured as a separate communication interface for every database, or may be configured as a common communication interface. Furthermore, although the transmission/reception unit 36 and the transmission/reception unit 37 are separately provided, the transmission/reception unit 36 and the transmission/reception unit 37 may be physically the same communication interface. Similarly, at least one of the transmission/reception unit 36 or the transmission/reception unit 37 may be physically the same communication interface as the reception unit 31 and the transmission unit 34.

The processing unit 32 communicates with the licensing database 180, the protection target information database 160, the equipment authorization database 170, and the IPC database 190 via the transmission/reception unit 37, and reads or writes data or information in an area licensing procedure, a communication device registration procedure, a spectrum grant procedure, and the like to be described later. In the following description, an operation performed independently by the spectrum management server 130 is assumed to be performed by the processing unit 32.

The process of each block of the spectrum management server 130 is configured by a hardware circuit, software (program or the like), or both of them. A function of the spectrum management server 130 may be implemented by causing a computer to execute a program. The storage unit 35 is configured by any hardware such as a memory device, a magnetic storage device, and an optical disk. The storage unit 35 may include a database. The storage unit 35 may be externally connected to the spectrum management server 130 in a wired or wireless manner instead of being provided in the spectrum management server 130.

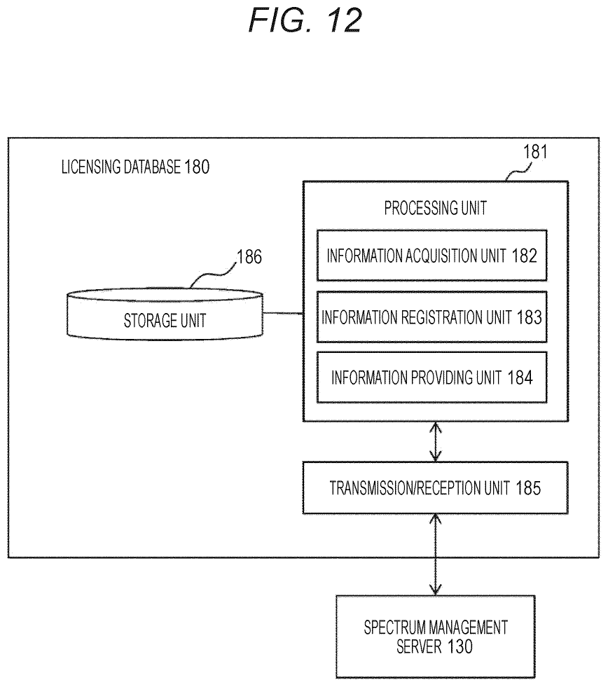

FIG. 12 is a block diagram illustrating an example of the licensing database 180. The licensing database 180 corresponds to a database device according to the present embodiment. The licensing database 180 includes a processing unit 181, a transmission/reception unit 185, and a storage unit 186. The processing unit 181 includes an information acquisition unit 182 and an information providing unit 184.

The transmission/reception unit 185 communicates with the spectrum management server 130. The transmission/reception unit 185 includes a transmission unit that transmits information, data, or the like to the spectrum management server 130, and a reception unit that receives information, data, or the like from the spectrum management server 130. Communication between the transmission/reception unit 185 and the spectrum management server 130 may be wired or wireless. In a case of wireless communication, the transmission/reception unit 185 may include one or more antennas.

The processing unit 181 can exchange data or information with the spectrum management server 130 via the transmission/reception unit 185.

The information acquisition unit 182 acquires, from the spectrum management server 130, information regarding an area and a spectrum range for which acquisition of a license has been permitted for the communication device 110 operated by each of a plurality of operators. On the basis of the acquired information, an information registration unit 183 registers or stores, in the storage unit 186, licensing data in which information regarding an operator (identification information of an operator), information regarding an area (identification information of an area), information regarding a spectrum range (identification information of a spectrum range), and the like are associated with each other. A registration time of the licensing data may be associated with the licensing data. The registration time may be a time at which the licensing data is generated or a time at which acquisition of the license is permitted. In a case of a configuration in which a registration request is received from the spectrum management server 130 or the like and the licensing data is stored (registered) in the storage unit 186, the registration request may include the registration time. The registration time may be a transmission time of the registration request. Furthermore, the information registration unit 183 may create a list (a licensee order or a license area creation order for every license spectrum range described above) representing an order of operators for which the licensing data is registered for every spectrum range, and store the list in the storage unit 186.

The storage unit 186 includes a database that stores the licensing data. Furthermore, the storage unit 186 stores other data such as order information of the operator described above. Furthermore, in a case where a function of the licensing database 180 is implemented by causing a processor such as a CPU to execute a program, the program may be stored in the storage unit 186. The storage unit 186 is configured by any hardware such as a memory device, a magnetic storage device, and an optical disk. The storage unit 186 may be disposed not in the licensing database 180 but as a server in a communication network such as the Internet, and may be connected to the spectrum management server 130 in a wired or wireless manner.

Upon receiving a provision request for information (order information) regarding a priority order of the operator for the target spectrum range from the spectrum management server 130, the processing unit 181 determines the priority order of the operator on the basis of the licensing data stored in the database. For example, an order of operators for which the licensing data including the information regarding the target spectrum range is registered in the database is stored in a list for every spectrum range, and an order of operators specified on the basis of the list is set as the priority order of the operators. Alternatively, the priority order of the operators may be in ascending order of the registration time of the licensing data. The processing unit 181 obtains information indicating the determined priority order as order information. This order information is used, for example, to determine allocation in a case of allocating an interference budget in units of area of individual operators as described later. The interference budget in units of area of individual operators corresponds to an aggregate interference amount for every area allowed to be given to a protection target entity (for example, a calculation reference point to be described later) from a communication device group in the area.

The information providing unit 184 provides the order information determined by the processing unit 181 to the spectrum management server 130 as a response to the provision request from the spectrum management server 130 for the target spectrum range. For example, the spectrum management server 130 allocates the interference budget for the target spectrum range in units of license area of a plurality of operators on the basis of the priority order of the operators sequentially indicated by the information, and further distributes the interference budget for each area to the communication devices in the area, thereby determining the interference budget of the communication device operated in each area. Moreover, the maximum transmission power of the communication device is determined on the basis of the interference budget of the communication device.

### [Procedure]

Regarding procedures described below, for example, a dedicated web portal or the like provided by an administrator of the spectrum management server 130 is used as a means for the user of the communication device 110 to notify the spectrum management server 130 of some information or message. The user accesses the dedicated web portal or the like by using a separate user device, and performs an operation of giving a notification of the information or message.

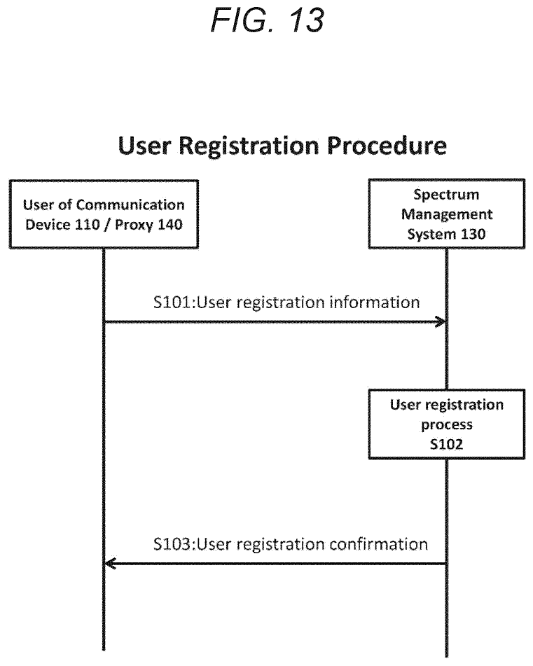

FIG. 13 is a sequence diagram illustrating an example of a user registration procedure. User registration information is transmitted to the spectrum management server 130 by using the user device 150 of the user (S101). The spectrum management server 130 performs a registration process of registering the user (S102), and issues information such as a user registration identifier. The spectrum management server 130 transmits user registration confirmation including information such as the issued user registration identifier to the user device 150 (S103).

### [Area Licensing Procedure]

The area licensing procedure is a procedure for acquiring, from the spectrum management server 130, a license in units of area necessary for the user to use a target frequency band. Here, the license area in the present embodiment has the following features.
A specific spectrum range is linked with the license area, as a license frequency.
A communication device installable area is provided in the license area (note that, this does not mean that radio waves may be freely emitted within the communication device installable area).
The license area is treated as an area protected from interference (interference protection area).
Construction of the license area is accepted on the first-come, first-served (FCFS) basis.
Spectrum use authorization for communication devices in the license area is performed in accordance with the all-come all-served (ACAS) principle.

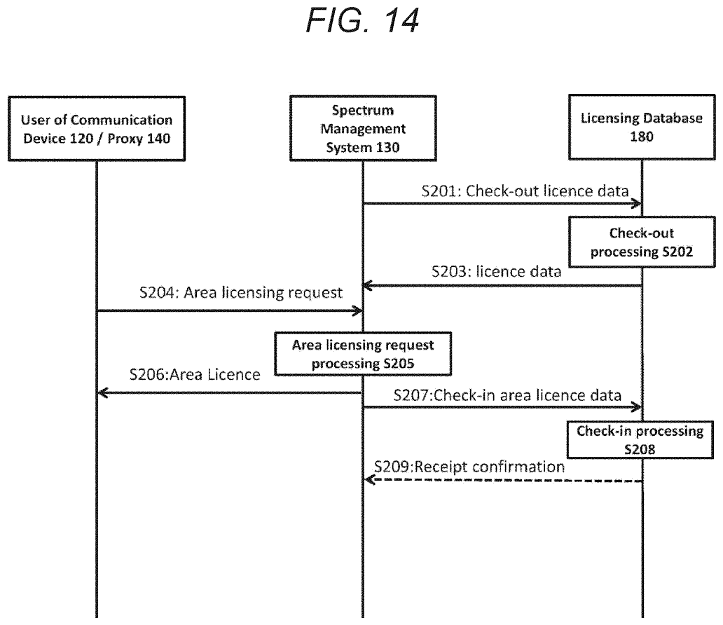

FIG. 14 is a sequence diagram illustrating an example of the area licensing procedure.

As a premise, in this procedure, a check-out/check-in mechanism in is used for data update of the licensing database 180.

The check-out refers to a process of locking a certain data record so that the data record cannot be edited or deleted on the database, while acquiring the latest data from the database. In contrast, the check-in refers to a process in which a person who has performed the check-out unlocks the data record being checked out while overwriting the latest version of the data record on the database with new data.

A purpose of the check-out/check-in mechanism is to avoid conflict due to simultaneous update of data by a plurality of spectrum management servers 130, and to avoid occurrence of harmful interference due to the conflict. The spectrum management server 130 first checks out data of the licensing database 180 so that another spectrum management server 130 cannot access the licensing database 180 to change the data (particularly, add new data and modify existing data). In other words, the licensing database 180 has functions of locking data by check-out and unlocking by check-in.

Although the terms “check-out” and “check-in” are used for convenience, if there is a process or a procedure that can similarly avoid the conflict, the process or the procedure may be substituted.

Upon receiving a check-out request from the spectrum management server 130 (S201), the licensing database 180 extracts the current data and performs check-out processing (S202). Here, the licensing database 180 may set a valid period of check-out. After completion of the check-out processing, the licensing database 180 notifies the spectrum management server 130 of the checked out data and the check-out valid period (if set) (S203)

The user of the communication device 110 notifies the spectrum management server 130 of an area licensing request by using the user device 150 (S204).

The area licensing request may include the following information.
User registration identifier (required)
Request type
   New, Update, Delete, and the like
License area information (required)
   License area ID
      The License area ID may be included in a case where the request type is Update or Delete.
      In a case where the license area ID is included when the request type is New, the license area ID may be used as a desired value of the license area ID.
   License spectrum range
      The License spectrum range may be included when the request type is New. The License spectrum range is treated as a desired spectrum range.
   Information regarding license area
      In a case where the request type is New, this information indicates an outer shape of a newly desired license area.
      In a case where the request type is Update, this information indicates that the existing license area designated by the license area ID is desired to be changed to an outer shape indicated in this information.
      Any of the following formats may be used.
         Center position coordinates and radius
         Polygon having position coordinates of three or more points
         Predefined area identifier or area name
         Administrative divisions, and the like

The spectrum management server 130 performs area licensing process on the basis of the licensing data checked out and the information included in the area licensing request (S205). In the area licensing process, the spectrum management server 130 determines whether or not a condition (license permission condition) related to permission of the license area is satisfied.

Specifically, it is desirable to perform the following processes.

### When the Request Type is New:

In a case where the desired area overlaps at least partially with a license area (existing license area) of another user included in the licensing data, and the desired spectrum range also overlaps at least partially with the existing license area, it is determined that the request cannot be accepted (is not permitted).
   When the request type is Update:
In a case where the license area ID does not correspond to any of the existing license areas of the same user as the user who has transmitted the area licensing request, it is determined that the update is not possible (is not permitted).
In a case where the area outer shape after update overlaps at least partially with an existing license area of another user included in the licensing data, it is determined that the update of the license area of the user who has transmitted the area licensing request is not possible (is not permitted) (note that, a case is assumed in which the spectrum range is the same as or overlaps at least partially with that of the existing license of another user).

### When the Request Type is Delete:

In a case where the license area ID does not correspond to any of the existing license areas of the same user as the user who has transmitted the area licensing request, it is determined that the deletion is not possible.

In a case where it is determined that the case of not permitting is not applicable in the processing described above, it is determined to permit the area licensing request. For example, in a case where the desired area does not overlap with the license area of another user in a case of New or Update, it is determined to permit the area licensing request (permit acquisition of the license by the user). Furthermore, in a case where the desired spectrum range of the user and the spectrum range of another user do not overlap in a case of New or Update, it is determined to permit the area licensing request (permit acquisition of the license by the user).

The spectrum management server 130 transmits a response (licensing response) including information corresponding to the determination result to the user (S206). The response includes, for example, information indicating whether or not to permit the license. Furthermore, in a case where the license granting is permitted, the response includes information about the permitted license area and may further include information about the permitted spectrum range. Furthermore, the spectrum management server 130 registers data in the licensing database 180 at the time of check-in, on the basis of the information about the permitted license area (S207, S208, S209). Specifically, the above-described licensing data is registered (added). At this time, the licensing database 180 may update the list indicating the order of the operators described above for the corresponding spectrum range.

Here, when the request type of the area licensing request is New or Update, the spectrum management server 130 may determine a communication device installable area in the license area in accordance with the condition in step S206 described above, and notify the user of the determined information. For example, in a case where a limit based on an index such as power flux density (PFD) is provided at an end of the license area, it is assumed that it is difficult to enable installation of the communication device in all places in the license area. Therefore, the spectrum management server 130 may obtain, as the communication device installable area, an area in which the communication device can be freely installed without exceeding the limit of the power flux density or the like within the permitted license area (desired license area).

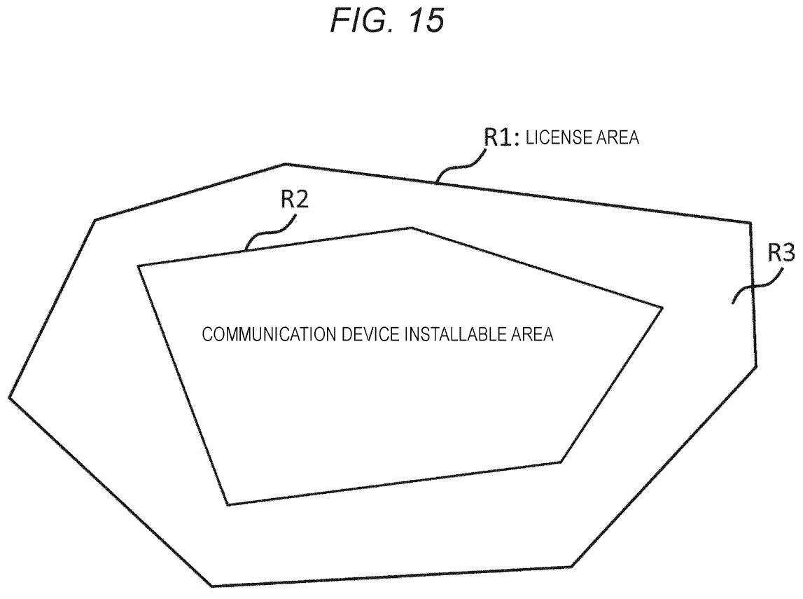

FIG. 15 illustrates a relationship between a license area and a communication device installable area. An area R3 other than a communication device installable area R2 in a license area R1 is an area (installation restricted area) in which the communication device cannot be installed because there is a possibility of exceeding a limit of power flux density (PFD) or the like at an end of the license area. Hereinafter, an example of determining the communication device installable area R2 will be described.

Hereinafter, a power flux density will be described as an example of a limit. Of course, another index may be used.

Regarding a radio wave emitted from a position M_{Device} of a communication device, a power flux density PFD (M_{Ref, x}, M_{Device}) [dBm/m²/MHz] at a position coordinate M_{Ref}, x of a certain calculation target point x can be calculated, for example, as in the following Expression (3). In the case of this example, the calculation target point x corresponds to a point at an end of the license area.

$$\begin{matrix}[ Math . 4 ] & \\ PFD ( {M}_{Ref , x} , {M}_{Device} ) = {P}_{Tx , EIRP} - {G}_{Tx , Max} + {G}_{Tx} ( {M}_{Ref , x} , {M}_{Device} ) - {L}_{Path} ( {M}_{Ref , x} , {M}_{Device} ) + 10 log ( 4 π / {λ}^{2} ) & ( 3 )\end{matrix}$$

P_{Tx, EIRP}: Maximum transmission EIRP of communication device (Numerical value defined with device class, or the like)
G_{Tx, Max}: Maximum antenna gain of communication device
M_{Ref, x}: Position coordinates of calculation target point x (Latitude, longitude, and the like. Height may be included)
M_{Device}: Position coordinates of communication device (Latitude, longitude, and the like. Height may be included)
G_{Tx} (M_{Ref, x}, M_{Device}): Antenna gain in direction from communication device Position coordinates M_{Device} to position coordinate M_{Ref, x} of calculation target point x
L_{Path}(M_{Ref, x}, M_{Device}): Path loss in direction from communication device Position coordinates M_{Device} to position coordinate M_{Ref, x} of calculation target point x
λ: wavelength

Expression (3) is obtained by changing, for the purpose of this document, notation of an equation adopted by the SAS for the US-Canada border coordination in the CBRS. The original is defined in WINNF-TS-0061-V1.5.1.

Note that, although numerical calculation of Expression (3) described above is expressed with logarithms, the calculation may be performed with antilogarithms.

When Expression (3) is transformed, the following algorithm can be used to obtain whether or not a certain point M_{LA, p} with an index

$$1 \leq p \leq P$$

in a desired license area M_{LA} can be included in M_{AllowedLocation} (a set of allowable position coordinates) of a set of position coordinates of the communication device where a PFD limit value PFD_{Limit} is not exceeded. Note that this algorithm is merely an example, and if there is an algorithm that can obtain an equivalent or similar result, the algorithm may be substituted.

```
//// START ////
M_{AllowedLocation} = Φ /// Initial value is empty set
for p = 1: P/// Loop by location in desired license area
    isExceeded = false; /// Limit-value-exceeded flag. Initial value is false.
    for x = 1: X /// Loop regarding calculation target point
      if PFD_{Limit} & P_{Tx} − G_{Tx Max} + G_{Tx}(M_{Ref x}, M_{LA, p}) − L_{Path}(M_{Ref. x},
      M_{LA, p})+ 10log(4π/λ²)
          isExceeded = true; ///Flag is set since limit value is exceeded
          break; /// Loop regarding calculation target point is broken
      end
    end
    if isExceeded == false /// Case where flag is not set (limit is not
    exceeded)
      M_{AllowedLocation} += M_{LA, pi} /// Location M_{LA, p} in desired license
      area is included in M_{AllowedLocation}
    end
end
////// END //////
```

The spectrum management server 130 notifies the user of the set of position coordinates included in M_{AllowedLocation} or information indicating an area outer shape obtained from M_{AllowedLocation}, as information about the communication device installable area (S206 described above). Furthermore, the spectrum management server 130 desirably registers similar information in the licensing database 180 (S207 to S209 described above).

In the numerical calculation of Expression (3) described above, maximum transmission EIRP and a maximum antenna gain of the communication device 110 are required. These can be acquired, for example, by any of the following means. However, the following means is merely an example, and other means by which equivalent information can be obtained may be used.
The area licensing request (see S204) is made to include the maximum transmission EIRP and the maximum antenna gain of the communication device 110 scheduled to be installed, and the spectrum management server 130 acquires the maximum transmission EIRP and the maximum antenna gain from the area licensing request.
The area licensing request is made to include information indicating a product model of the communication device to be installed or an authentication number of an information regulatory authority (in a case of an antenna integrated type) or antenna model information (in a case of an antenna external type), and the spectrum management server 130 specifies the maximum transmission EIRP and the maximum antenna gain from the information included in the area licensing request.

The example of a limit based on the index of the power flux density described above has been described. However, in a case where a limit based on a plurality of indexes is provided, it is desirable to determine position information corresponding to M_{AllowedLocation} with each index and determine the communication device installable area from the position information common to all the indexes.

Similarly, in a case where the numerical calculation as described above is performed using product models of a plurality of communication devices or authentication numbers of information regulatory authorities (in a case of the antenna integrated type) or antenna model information (in a case of the antenna external type), it is desirable to determine position information corresponding to M_{AllowedLocation} on such a “model/class basis” and notify the user of the individual position information.

Moreover, in the example described above, a place where the limit is applied has been described as an end of the license area, but it is a matter of course that the communication device installable area may be determined in consideration of the limit applied to other places. For example, power limit outside the license area may be considered.

Furthermore, in the communication device installable area determined on the basis of the applied index, it is desirable that a minimum necessary coverage required for the communication device to provide the communication service do not exceed the license area regardless of where the communication device is installed. In other words, a limit on a coverage end or the outside may be determined so that the minimum necessary coverage for the communication device to provide the communication service does not exceed the license area, and the communication device installable area may be determined on the basis of the limit. As a result, in a case where license areas of a plurality of different operators are in a place where there is a possibility of mutual interference, even if the number of communication devices increases in a license area of a higher-order operator, it is not necessary to perform an interference budget redistribution process (reallocation process) described later on a communication device of a lower-order operator.

Note that, in a case where a limit based on the index of the power flux density or the like described above is not defined in advance, the license area and the communication device installable area may be the same.

### [Communication Device Registration Procedure]

The communication device registration procedure is a procedure for registering the communication device 110 in the spectrum management server 130.

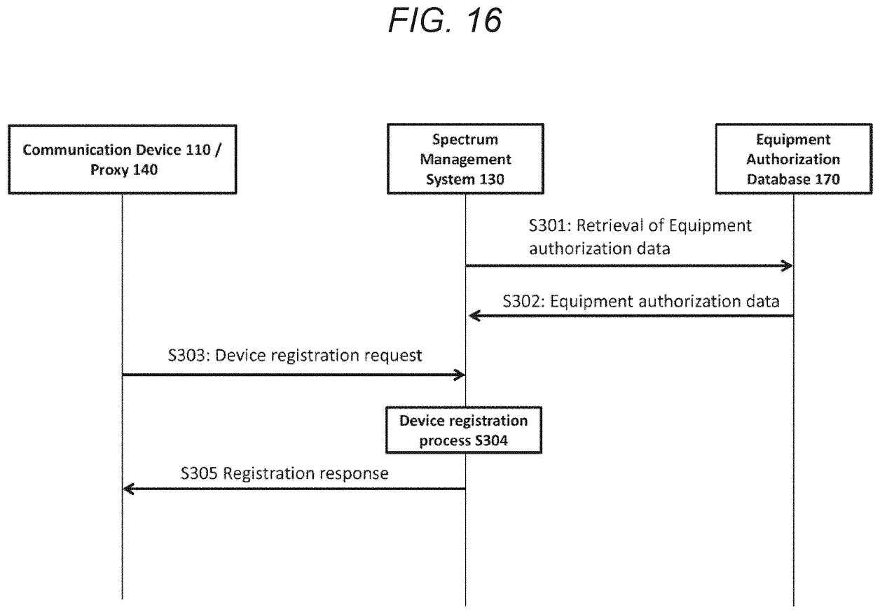

FIG. 16 is a sequence diagram illustrating an example of a flow of the communication device registration procedure. The spectrum management server 130 acquires equipment authorization data from the equipment authorization database 170 (S301, S302).

The communication device 110 or the proxy 140 that substitutes for one or more communication devices 110 transmits a device registration request to the spectrum management server 130 (S303). Here, the device registration request may include the following information. Note that position information, antenna information, air interface information, and the like may be provided by other means, such as directly inputting to the SAS via another interface like multi-step registration of the CBRS.
User registration identifier
Equipment authorization ID
Device serial number
Device class information
Product model information
   Model number
   Model name, and the like
Position information
   Latitude, longitude
   Position uncertainty
Air interface information
   Wireless communication standard information, and the like
Antenna information
   Antenna installation height information
      Height (ground level, sea level, and the like)
      Height uncertainty
   Information allowing an antenna pattern to be specified (the followings are examples)
      Antenna model
      Antenna pattern ID (in a case where an antenna pattern is separately recorded in a database or the like)
      Peak antenna gain
      Antenna half-value width (horizontal and/or vertical)
      Machine tilt angle
      Electric tilt angle
      Front back ratio
      Antenna pattern (horizontal and/or vertical)

The spectrum management server 130 performs a registration process of the communication device 110 on the basis of the equipment authorization data of the communication device 110 (S304).

In the registration process, the following processes are desirably performed.
In a case where the equipment authorization ID of the communication device 110 is not included in the equipment authorization data, the registration is rejected.
In a case where a position of the communication device 110 or a region or a space indicated by the position uncertainty of the communication device 110 is not completely included in the communication device installable area of the registered license area linked with the user registration identifier, the registration is rejected.
In a case where the device class, the product model, or the antenna model of the communication device 110 does not correspond to the communication device installable area on the model/class basis calculated in the area license procedure, the registration is rejected.
In a case where it is necessary to permit the license area according to the device class or the like, the area linked with the communication device 110 is permitted as the license area (a form like medium power shared access license is assumed).
In a case where the communication device 110 can be registered normally (in a case where the above-described reason for rejection does not apply), the communication device 110 may be registered and the device registration ID may be issued.

After the registration process of the communication device 110 is normally completed, the spectrum management server 130 transmits a registration response indicating normal completion to the communication device 110 (S305).

### [Spectrum Grant Procedure]

The spectrum grant procedure is a procedure in which the communication device 110 acquires a spectrum grant (grant), which is permission for spectrum use, from the spectrum management server 130.

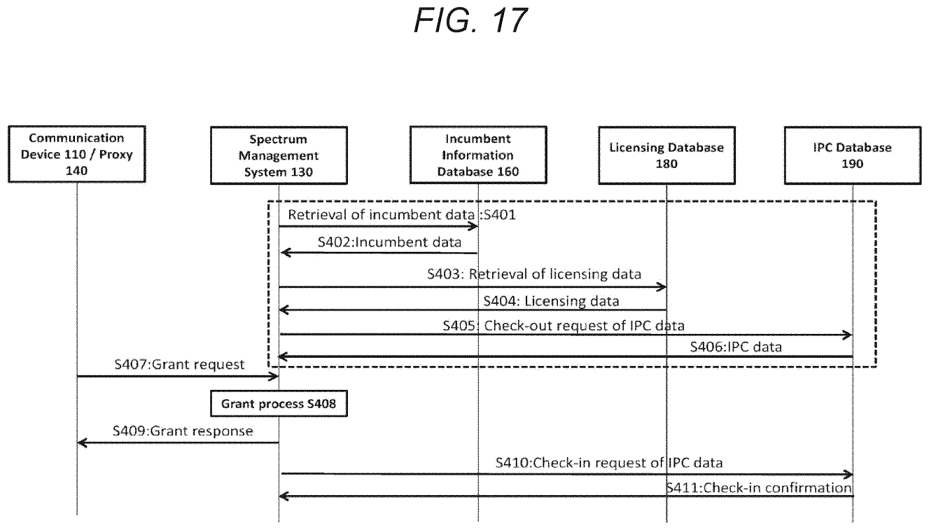

FIG. 17 is a sequence diagram illustrating an example of the spectrum grant procedure.

The spectrum management server 130 acquires data of the protection target system (Incumbent data), licensing data, and IPC data (S401, S402, S403, S404, S405, S406). Here, regarding the IPC data, the IPC database 190 may perform a check-out/check-in function as performed by the licensing database 180 in the area licensing procedure. In this example, a case where the check-out/check-in function is performed is illustrated.

The communication device 110 or the proxy 140 that substitutes one or more communication devices transmits a grant request to the spectrum management server 130 (S407). Here, the grant request may include the following information. Note that the term “device” in “device identifier” and “device serial number” refers to a communication device.
Device identifier (any of the following)
   ID at least linked with a combination of the equipment authorization ID and the device serial number
   Device registration ID
   Besides, ID that allows communication device to be uniquely specified
Desired grant information (may or may not be provided, because the license spectrum range has already been determined)
   Spectrum range
   Maximum transmission EIRP

The spectrum management server 130 performs a grant process on the basis of the grant request (S408). In the grant process, the following processes are desirably performed.
In a case where the device identifier included in the grant request does not match the device identifier of the registered communication device 110, the grant issuance is rejected.
In a case where the spectrum range of the desired spectrum grant (the desired grant) in the grant request does not match the license spectrum range or is not included in the license spectrum range, the grant issuance is rejected.
In a case where the position of the communication device 110 is a place that requires protection of the protection target system (Incumbent protection), protection calculation for the protection target system is performed.
In a case where the position of the communication device 110 is a place that requires protection for the license area of the preceding user to which the same spectrum range is allocated, protection calculation for the license area of the target preceding user is performed.
The grant issuance is determined according to the result of the protection calculation described above (details will be described later).
   [about Protection Calculation]

In the present embodiment, protection calculation of a protection target system that is using the same spectrum range and protection calculation for a license area of a preceding user to which the same spectrum range is allocated are performed. The protection target system and the license area of the preceding user are examples of the protection target entity. In the present embodiment, the IPC database 190 records metric calculation values regarding the interference protection criterion (IPC) in all the protection target entities. Here, aggregate interference power will be described as a representative example of the IPC.

The IPC database 190 records an aggregate interference power map as illustrated in FIG. 10 for every protection target entity.

Protection for the protection target system takes a form of an area (left diagram in FIG. 10) or a point (right diagram in FIG. 10) according to the protection target system. Here, for convenience, protection methods for the area and the point are referred to as “area protection” and “point protection”, respectively.

As described above, the left diagram of FIG. 10 illustrates an example of the aggregate interference power map in a protection area, and the right diagram illustrates an example of the aggregate interference power map at a protection point. The case of the protection point corresponds to a case where the protection target system is, for example, a receiver itself. The aggregate interference power map to be recorded is only aggregate interference power calculated at the receiver. In the case of the protection area, protection of the protection target system corresponds to protection of a certain area including, for example, a position of the receiver. A license area of a preceding user is also the protection area. It is important that the entire protection area is protected from the aggregate interference power. Therefore, the protection area is sectioned into grids, and aggregate interference power calculated at each grid point (each point) is recorded. Each grid point (point) can be treated as the protection point. The recorded aggregate interference power is managed to meet an aggregate interference power threshold or a protection criterion for every protection entity defined as the IPC.

For example, it is assumed that the communication device 110 of a certain user has not acquired any spectrum grant yet. Then, it is assumed that the proxy 140 transmits a grant request for N pieces of the communication devices 110 of the user to the spectrum management server 130. Furthermore, for simplifying the description, it is assumed that all the N pieces of the communication devices 110 are located in a neighborhood area (protection calculation target area) of the same protection target entity. Using the registration information of the communication device 110, the spectrum management server 130 calculates the right side of the inequality expressed in the following Expression (4) for every protection point for one protection target entity.

$$[ Math . 5 ]$$

$${I}_{Headroom , k [ dBm ]} \geq {\sum }_{n = 1}^{N} 1 {0}^{\frac{{P}_{MaxEIRP , n [ dBm ]} - {G}_{PeakTx , n [ dB ]} + {{G}_{Tx} ( k , n )}_{[ dB ]} - {{L}_{Path} ( k , n )}_{[ dB ]} + {G}_{Rx , k [ dB ]}}{10}} \qquad ( 4 )$$

I_{Headroom, k[dBm]}: Headroom margin (interference margin) of aggregate interference power at k-th protection point of protection entity.

$${I}_{Headroom , k [ dBm ]}$$

can be calculated as follows on the basis of the aggregate interference power threshold

$${I}_{Thres [ dBm ]}$$

and the aggregate interference power record value

$${I}_{Agg , k [ dBm ]}$$

at a k-th protection point (corresponding to aggregate interference power by the communication device of the preceding user).

$$[ Math . 6 ]$$

$${I}_{Headroom , k [ dBm ]} = 10 {log}_{10} ( 1 {0}^{\frac{{I}_{Thres [ dBm ]}}{10}} - 1 {0}^{\frac{{I}_{Agg , k [ dBm ]}}{10}} ) \qquad ( 5 )$$

P_{MaxEIRP, n[dBm]}: Maximum transmission EIRP of n-th communication device
G_{PeakTx, n[dB]}: Peak antenna gain of n-th communication device
G_{Tx}(k, n)_{[dB]}: Antenna gain in direction toward protection point k from n-th communication device
L_{Path}(k, n)_{[dB]}: Path loss between n-th communication device and protection point k
G_{Rx, k[dB]}: Reception antenna gain assumed at protection point k

The sigma on the right side of Expression (4) represents single station interference of one communication device to the k-th protection point of the protection entity, and a sum is calculated by the sigma to indicate that aggregate interference power from the N pieces of the communication devices is calculated. In practice, all the N pieces are not always located in a neighborhood area (protection calculation target area) of the same protection target entity, and thus, in implementation, it is necessary to appropriately check which protection target entity the neighborhood area having each communication device belongs on the basis of the position of each communication device, to calculate the aggregate interference power.

In the case of the point protection, in a case where a value calculated on the right side of Expression (4) satisfies the inequality of Expression (4), it is determined that the protection target entity can be protected. In the case of the area protection, in a case where the number of points (grid points) satisfying the inequality is a predetermined value or more, it is determined that the protection target entity can be protected. Note that the “predetermined value” is expressed by a ratio, for example, and can be expressed as 95% or more, 70% or more, or the like. The “predetermined value” may be flexibly set according to the number of points with respect to an area size, a grid size with respect to the area size, or the like.

In a case where it is determined that all the protection target entities determined with respect to the positions of all the communication devices 110 can be protected, the grant issuance to each of the communication devices 110 based on the grant request is determined. At this time, the spectrum management server 130 performs notification or transmission of the grant issuance to the communication device 110 or the proxy 140 thereof (S409). Moreover, a check-in request for the value calculated on the right side of Expression (4) described above is made to the IPC database 190 (S410, S411). That is, the IPC database 190 updates the aggregate interference power map on the basis of the following calculation.

$$[ Math . 7 ]$$

$${10}^{\frac{{I}_{Agg , k [ dBm ]}}{10}} += {\sum }_{n = 1}^{N} {10}^{\frac{{P}_{MaxEIRP , n [ dBm ]} - {G}_{PeakTx , n [ dB ]} + {{G}_{Tx} ( k , n )}_{[ dB ]} - {{L}_{Path} ( k , n )}_{[ dB ]} + {G}_{Rx , k [ dB ]}}{10}} \qquad ( 6 )$$

Whereas, it is not always possible to determine that all the protection target entities can be protected (satisfy the protection criterion). In this case, it is desirable to perform at least the following processes.
For the communication device 110 involved in the aggregate interference to the protection target entity that does not satisfy the protection criterion, the maximum value of allowable transmission power is determined by distribution of an interference budget. For example,

$${I}_{Headroom , k [ dBm ]}$$

can be used as the interference budget and can be distributed using an iterative allocation process (IAP) used in the CBRS, a fixed margin-based method defined in the ECC Report 186, or the like.
In a case where the communication device 110 is involved in aggregate interference to a plurality of protection target entities that do not satisfy the protection criterion, a minimum value of a maximum value of allowable transmission power determined for each is treated as the maximum value of the allowable transmission power. In a case where the maximum value of the allowable transmission power is higher than maximum transmission power defined by the device class of the communication device, the device class defined value is used. The value of the right side of the inequality of Expression (4) is updated on the basis of the determined maximum value of the allowable transmission power, and a check-in request is made to the IPC database 190.
In a case where

$${I}_{Headroom , k [ dBm ]}$$

is not sufficient (for example, in a case where the maximum value of the allowable transmission power of a certain number or more of the communication devices 110 is less than a minimum transmission power capability value of the communication device 110, in a case where desired communication quality or coverage cannot be obtained in a case of being based on the maximum value of the allowable transmission power of the certain number or more of the communication devices, or the like), the license area is not changed, the spectrum range linked with the license area is changed, and the above process is repeated.

In the example described above, it has been assumed that the communication device 110 of a certain user has not acquired any spectrum grant yet. Whereas, in a situation where the user has already installed the communication device 110 in the license area and has acquired the spectrum grant, a situation can also be assumed in which the communication device 110 is newly additionally installed. At this time, in a case where

$${I}_{Headroom , k [ dBm ]}$$

at a check-out time point is a sufficient as the interference budget, it is possible to issue a grant to the new communication device 110 by a process similar to that described above. However, it is of course possible that an amount of

$${I}_{Headroom , k [ dBm ]}$$

is not sufficient. In such a case, the spectrum grant may be issued to the new communication device 110 by redistributing the interference budget between with the communication device 110 previously installed in the same license area by the user. Assuming that a time of grant issuance to the previously-installed communication device 110 is t0 and a time of the grant process to the new communication device 110 is t1, interference budgets redistributable in total at t1 (total interference budget)

$${I}_{budget , k} ( {t}_{1} )$$

is as follows.

$$[ Math . 8 ]$$

$${{I}_{budget , k} ( {t}_{1} )}_{[ dBm ]} = 10 {log}_{10} ( {10}^{\frac{{{I}_{Headroom , k} ( {t}_{1} )}_{[ dBm ]}}{10}} + {10}^{\frac{{{I}_{Agg , k} ( {t}_{0} )}_{[ dBm ]}}{10}} ) \qquad ( 7 )$$

Naturally, at a time point when the spectrum grant is to be issued to the new communication device 110, in a case where

$${{I}_{Headroom , k} ( {t}_{1} )}_{[ dBm ]}$$

does not exist at all, the interference budget redistributable in total at time t1 (total interference budget)

$${I}_{budget , k} ( {t}_{1} )$$

is as follows.

$$[ Math . 9 ]$$

$${{I}_{budget , k} ( {t}_{1} )}_{[ dBm ]} = {{I}_{Agg , k} ( {t}_{0} )}_{[ dBm ]} \qquad ( 8 )$$

By redistribution using the total interference budget determined in this manner, it is possible to issue a grant to the new communication device 110 while satisfying the premise of the “spectrum use authorization for communication devices in the license area is performed in accordance with the all-come all-served (ACAS) principle” described above. At this time, some of the existing communication devices 110 may need a change in maximum transmission power. It is desirable to notify such the existing communication devices 110 of the changed maximum transmission power by a heartbeat procedure to be described later.

### [Heartbeat Procedure]

The heartbeat procedure is a procedure performed by the communication device 110 to receive and reflect a parameter change command of the spectrum grant from the spectrum management server 130. In other words, the communication device 110 can check necessity of a parameter change in each procedure.

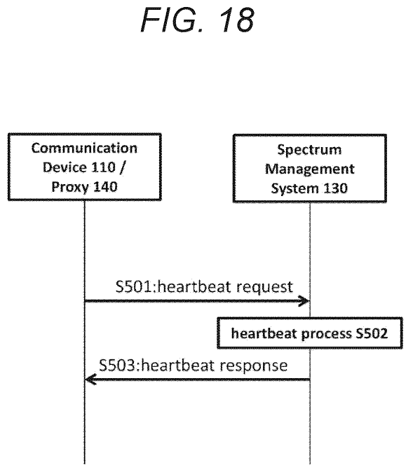

FIG. 18 is a sequence diagram illustrating an example of the heartbeat procedure. In the heartbeat procedure, the spectrum management server 130 receives a heartbeat request from the communication device 110 (S501), performs a heartbeat process on the basis of the heartbeat request (S502), and transmits a heartbeat response including a result of the heartbeat process to the communication device 110 (S503). Although the communication device 110 triggers the heartbeat procedure, the heartbeat procedure may be performed by a trigger of the spectrum management server 130 in some cases. The heart bit response can include, for example, information regarding a change in maximum transmission power or spectrum range, as a parameter change command accompanying addition of a new communication device 110 or a change (addition, deletion, or the like) of the protection target entity.

Processes and procedures of the spectrum management server 130 that may affect a result of the heartbeat process will be described below.

### [Various Database Update Checking Procedure]

It is desirable that the spectrum management server 130 periodically check whether or not at least the protection target information database 160 has been updated. The spectrum management server 130 may check the update after receiving the heartbeat request. This is because, if a new protection target system has been added, it may be necessary to issue a parameter change instruction to the communication device 110 for which the grant has been issued, in order to protect the protection target system. In a case where the protection target information database 160 has been updated, whether or not the IPC database 190 has been updated is also checked.

The spectrum management server 130 may directly acquire information about the new protection target system from the user of the protection target system. In this case, the spectrum management server 130 creates a new data record related to the protection target system, in the protection target information database 160. Furthermore, a new data record related to the system is similarly created in the IPC database 190. At this time, the spectrum management server 130 desirably creates initial data of the aggregate interference power map on the basis of order information of a licensee for every spectrum range (frequency block) recorded in the licensing database 180.

As a method for creating the initial data of the aggregate interference power map, the following method is assumed. A license area at a position where protection for the new protection target system needs to be considered is specified, an interference budget is distributed in units of license area, and a distribution amount is recorded.
For example, on the basis of the number of communication devices linked with the license area, the interference budget is equally distributed to the individual communication devices between the license areas.
For example, the interference budget is distributed on the basis of the number of communication devices linked with the license area and the order information of the related licensee. A single station interference amount between the protection target system and the communication device installable area in the license area is roughly estimated, and a value obtained by multiplying the single station interference amount by the number of communication devices is set as aggregate interference power from the license area. Furthermore, the aggregate interference power is sequentially calculated on the basis of the order, and a distribution amount of the interference budget to each communication device (an allocation amount of the interference budget to each communication device) is determined. The distribution amount may be increased as the order is higher, or the distribution amount may be determined by a weight based on the number of communication devices and the order. In the license area, the distribution amount determined in the license area may be equally distributed to the communication devices. The single station interference amount can be roughly calculated, for example, on the assumption that the communication device 110 emits radio waves from a place nearest to the protection target system in the communication device installable area. The place does not need to be the nearest, but it is desirable to select a place with the greatest interference (line-of-sight, no clutter, and the like).

Another spectrum management server 130 can acquire a recorded distribution amount at the time of update check, and can execute protection calculation of the protection target system with respect to the communication device managed by itself by using the distribution amount as the distributed interference budget.

### [Others: Redistribution of Interference Budget Between Communication Devices]

In the embodiment described above, as a case where redistribution of the interference budget occurs, a situation has been described in which a certain company additionally installs a new communication device in a license area in which the communication device is in operation. In addition to this, for example, the following redistribution case of the interference budget may occur. Case 1 and Case 2 are illustrated separately.

(Case 1) A communication device that is used for a highly urgent application (hereinafter, an emergency communication device) is registered, and the spectrum management server 130 receives an application for a spectrum grant from the emergency communication device.

Even in such a case, in a case where there is a sufficient headroom margin in the protection target entity that the emergency communication device can interfere with, the spectrum management server 130 may simply issue the spectrum grant by using the headroom margin similarly to the embodiment described above.

In a case where there is no sufficient headroom margin, the spectrum management server 130 performs an interruption process. Specifically, the spectrum management server 130 gradually collects an interference budget from the communication device to which the interference budget of the protection target entity with which the emergency communication device can interfere is distributed, allocates the collected interference budget to the emergency communication device, and issues the spectrum grant. For the communication device from which the interference budget has been collected, the spectrum management server 130 determines an adjustment amount of the maximum transmission power according to the collected amount, and notifies the communication device of the determined adjustment amount. A total collected amount of the interference budget is desirably an amount required by the emergency communication device (=a margin shortage amount). Furthermore, the amount of the interference budget collected from each communication device may be equal between the communication devices. Furthermore, the interference budget may be collected with inclination according to the order of the license area (for example, a higher order indicates a smaller amount, and a lower order indicates a larger amount). Each communication device adjusts the transmission power to reach a value determined on the basis of the redistributed interference budget.

(Case 2) The number of protection target systems is reduced, or a license area of a high-order operator disappears.

In such a case, there is a possibility that transmission power can be increased for the communication device 110 that has been restricted in transmission power due to the presence of the protection target system that disappears or the license area of the high-order operator that disappears. Therefore, in a case where the license area of the protection target system or the high-order operator disappears, the spectrum management server 130 may continue to determine whether the interference budget can be increased in units of valid license area, and if possible, the spectrum management server 130 may continue to redistribute the increased amount to the communication devices in the valid license area. In a case where there is a plurality of such license areas, the increased amount of the interference budget is distributed between the license areas. The distribution between the license areas may be equal, or the interference budget may be collected with inclination according to the order of the license area (for example, a higher order indicates a smaller amount, and a lower order indicates a larger amount). Examples of a case where the license area disappears include license waiver, expiration, and the like. The license waiver can be discriminated on the basis of, for example, license state information recorded in the licensing database 180. The expiration can be discriminated on the basis of valid period information recorded in the licensing database 180, for example.

As described above, according to the present embodiment, since a plurality of spectrum management servers each acquires and updates necessary information via the database 160 to 190, a direct synchronization process between the plurality of spectrum management servers is unnecessary. Therefore, aggregate interference protection of the existing system and operation of each communication device can be performed with a reduced operation load. Furthermore, regarding the operation of the communication device, it is also possible to appropriately protect first-come users from interference of subsequent users in coexistence between vertical users.

Note that the embodiment described above represents an example for embodying the present disclosure, and the present disclosure can be implemented in various other modes. For example, various modifications, substitutions, omissions, or combinations thereof are possible without departing from the gist of the present disclosure. Such modifications, substitutions, omissions, and the like are also included in the scope of the present disclosure, and are similarly included in the inventions disclosed in the claims and the equivalents thereof.

Furthermore, the effects of the present disclosure described in the present specification are merely an example, and there may be other effects.

Note that, the present disclosure can also have the following configurations.

### [Item 1]

A communication control device including:
a reception unit configured to receive a licensing request including information regarding a first area and a first spectrum range for which a first operator desires to acquire a license regarding spectrum use;
a processing unit configured to determine whether or not to permit acquisition of the license by the first operator on the basis of the licensing request and licensing data including information regarding a second area and a second spectrum range for which a license has been acquired by a second operator; and
a transmission unit configured to transmit a licensing response including information according to a determination result of the processing unit.

### [Item 2]

The communication control device according to Item 1, in which
the processing unit determines to permit acquisition of the license by the first operator in a case where the first area and the second area do not overlap with each other.

### [Item 3]

The communication control device according to Item 1 or 2, in which
the processing unit determines to permit acquisition of the license by the first operator in a case where the first spectrum range and the second spectrum range do not overlap with each other.

### [Item 4]

The communication control device according to any one of items 1 to 3, in which the processing unit determines not to permit acquisition of the license by the first operator in a case where the first area and the second area overlap at least partially with each other and the first spectrum range and the second spectrum range overlap at least partially with each other.

### [Item 5]

The communication control device according to any one of Item 1 to 4, in which
the processing unit acquires the licensing data of the second operator from a licensing database, and
in a case where the processing unit determines to permit acquisition of the license by the first operator, the processing unit generates licensing data including information regarding the first area and the first spectrum range for which the first operator has acquired the license, and adds the generated licensing data to the licensing database.

### [Item 6]

The communication control device according to any one of Items 1 to 5, in which
the transmission unit receives the licensing request from a user device of the first operator, and transmits the licensing response to the user device.

### [Item 7]

The communication control device according to any one of items 1 to 6, in which
the reception unit receives a grant request for requesting permission for use of a radio wave in the first spectrum range in the first area from a first communication device or a proxy that performs communication on behalf of the first communication device, the first communication device being operated by the first operator permitted to acquire the license,
the processing unit sets the second area as a protection area, the second area being an area of the second operator for which licensing has been acquired for the second spectrum range overlapping at least partially with the first spectrum range, and the processing unit acquires information indicating an interference margin of the protection area and allocates an interference budget to the first communication device on the basis of the interference margin to determine maximum transmission power of the first communication device, and
the transmission unit transmits a grant response including information regarding the maximum transmission power.

### [Item 8]

The communication control device according to Item 7, in which
in a case where there is one or more other first communication devices operated in the first area by the first operator permitted to acquire the license, the processing unit allocates an interference budget to the first communication device and reallocates an interference budget to the one or more other first communication devices on the basis of a total amount of an interference budget allocated to the one or more other first communication devices and an interference margin of the protection area, and the processing unit determines maximum transmission power of the first communication device and the one or more other first communication devices on the basis of the individual interference budgets.

### [Item 9]

The communication control device according to any one of items 1 to 8, in which
the reception unit receives a grant request for requesting permission for use of a radio wave in the first spectrum range in the first area from a first communication device or a proxy that performs communication on behalf of the first communication device, the first communication device being operated by the first operator permitted to acquire the license,
the second spectrum range overlaps at least partially with the first spectrum range, and
the processing unit allocates an interference budget to the first communication device and reallocates an interference budget to a second communication device operated by the second operator, on the basis of a total amount of an interference margin in a protection area of a protection target system and an interference budget that has been allocated to the second communication device, and the processing unit determines maximum transmission power of the first communication device and the second communication device on the basis of the individual interference budgets.

### [Item 10]

The communication control device according to Item 9, in which
the processing unit acquires a priority order of the first operator and the second operator on the basis of an order in which the first operator and the second operator have been permitted to receive a license for the first area and the second area, and the processing unit determines an interference budget for each of the first area and the second area on the basis of the priority order, and
the processing unit allocates an interference budget of the first area to one or more of the first communication devices belonging to the first area and allocates an interference budget of the second area to one or more of the second communication devices belonging to the second area.

### [Item 11]

The communication control device according to Item 10, in which
the processing unit determines an interference budget for each of the first area and the second area, further on the basis of a number of the first communication devices belonging to the first area and a number of the second communication devices belonging to the second area.

### [Item 12]

A database device including:
an information acquisition unit configured to acquire information regarding an area and a spectrum range for which acquisition of a license for spectrum use has been permitted for each of a plurality of operators;
a registration unit configured to register, in a database, licensing data in which information regarding each of the operators, information regarding the area, and information regarding the spectrum range are associated with each other, on the basis of the information acquired by the information acquisition unit;
a reception unit configured to receive a provision request from a communication control device that controls allocation of an interference budget, the provision request requesting, for a target spectrum range, provision of a priority order of the operators regarding allocation of the interference budget regarding a protection target entity;
a processing unit configured to determine a priority order of the operators on the basis of an order of the operators for which the licensing data including information regarding the target spectrum range indicated in the provision request is registered in the database; and
an information providing unit configured to provide the communication control device with information regarding a priority order of the operators.

### [Item 13]

The database device according to Item 12, in which
the database associates the licensing data with a time at which the licensing data is registered in the database, and
the processing unit determines a priority order of the operators on the basis of the time associated with the licensing data.

### [Item 14]

The database device according to Item 12 or 13, in which
the processing unit generates a list holding an order of operators for which the licensing data for the spectrum range has been registered in the database, and determines, on the basis of the list, an order of the operators for which the licensing data has been registered in the database.

### [Item 15]

A communication control method including:
receiving a licensing request including information regarding a first area and a first spectrum range for which a first operator desires to acquire a license regarding spectrum use;
determining whether or not a license permission condition is satisfied on the basis of the licensing request and licensing data including information regarding a second area and a second spectrum range for which a license has been acquired by a second operator; and
transmitting a licensing response indicating whether or not to permit acquisition of the license by the first operator in accordance with a determination result.

### [Item 16]

An information processing method including:
acquiring information regarding an area and a spectrum range for which acquisition of a license of spectrum use has been permitted for each of a plurality of operators;
registering, in a database, licensing data in which information regarding each of the operators, information regarding the area, and information regarding the spectrum range are associated with each other on the basis of the acquired information;
receiving a provision request from a communication control device that controls allocation of an interference budget, the provision request requesting, for a target spectrum range, provision of a priority order of the operators regarding allocation of the interference budget regarding a protection target entity;
determining a priority order of the operators on the basis of an order of the operators for which the licensing data including the information regarding the target spectrum range indicated in the provision request is registered in the database; and
providing information regarding the priority order of the operators to the communication control device.

### REFERENCE SIGNS LIST

31 Reception unit
32 Processing unit
33 Control unit
34 Transmission unit
Storage unit
36 Transmission/reception unit
37 Transmission/reception unit
100 Communication network
110 Communication device
110_1 Communication device
110_2 Communication device
110_3 Communication device
110_4 Communication device
110A Communication device
110B Communication device
110C Intermediate device (network manager)
120 Terminal
130 Communication control device (spectrum management server, spectrum management system)
130_1 Communication control device (spectrum management server, spectrum management system)
130_2 Communication control device (spectrum management server, spectrum management system)
130A Communication control device
130B Communication control device
140 Proxy
150 User device
160 Protection target information database (incumbent information database)
170 Equipment authorization database
180 Licensing database
181 Processing unit
182 Information acquisition unit
182 Processing unit
183 Information registration unit
184 Information providing unit
185 Transmission/reception unit
186 Storage unit
190 IPC database
1110 Communication device
1120 Communication device
1120 Terminal
1140 Assistance server
1150 Substitute server
2140 Common repository (IPC database)
2150 Spectrum management server

1. A communication control device comprising:
a reception unit configured to receive a licensing request including information regarding a first area and a first spectrum range for which a first operator desires to acquire a license regarding spectrum use;
a processing unit configured to determine whether or not to permit acquisition of the license by the first operator on a basis of the licensing request and licensing data including information regarding a second area and a second spectrum range for which a license has been acquired by a second operator; and
a transmission unit configured to transmit a licensing response including information according to a determination result of the processing unit.

2. The communication control device according to claim 1, wherein
the processing unit determines to permit acquisition of the license by the first operator in a case where the first area and the second area do not overlap with each other.

3. The communication control device according to claim 1, wherein
the processing unit determines to permit acquisition of the license by the first operator in a case where the first spectrum range and the second spectrum range do not overlap with each other.

4. The communication control device according to claim 1, wherein
the processing unit determines not to permit acquisition of the license by the first operator in a case where the first area and the second area overlap at least partially with each other and the first spectrum range and the second spectrum range overlap at least partially each other.

5. The communication control device according to claim 1, wherein
the processing unit acquires the licensing data of the second operator from a licensing database, and
in a case where the processing unit determines to permit acquisition of the license by the first operator, the processing unit generates licensing data including information regarding the first area and the first spectrum range for which the first operator has acquired the license, and adds the generated licensing data to the licensing database.

6. The communication control device according to claim 1, wherein
the transmission unit receives the licensing request from a user device of the first operator, and transmits the licensing response to the user device.

7. The communication control device according to claim 1, wherein
the reception unit receives a grant request for requesting permission for use of a radio wave in the first spectrum range in the first area from a first communication device or a proxy that performs communication on behalf of the first communication device, the first communication device being operated by the first operator permitted to acquire the license,
the processing unit sets the second area as a protection area, the second area being an area of the second operator for which licensing has been acquired for the second spectrum range overlapping at least partially with the first spectrum range, and the processing unit acquires information indicating an interference margin of the protection area and allocates an interference budget to the first communication device on a basis of the interference margin to determine maximum transmission power of the first communication device, and
the transmission unit transmits a grant response including information regarding the maximum transmission power.

8. The communication control device according to claim 7, wherein
in a case where there is one or more other first communication devices operated in the first area by the first operator permitted to acquire the license, the processing unit allocates an interference budget to the first communication device and reallocates an interference budget to the one or more other first communication devices on a basis of a total amount of an interference budget allocated to the one or more other first communication devices and an interference margin of the protection area, and the processing unit determines maximum transmission power of the first communication device and the one or more other first communication devices on a basis of the individual interference budgets.

9. The communication control device according to claim 1, wherein
the reception unit receives a grant request for requesting permission for use of a radio wave in the first spectrum range in the first area from a first communication device or a proxy that performs communication on behalf of the first communication device, the first communication device being operated by the first operator permitted to acquire the license,
the second spectrum range overlaps at least partially with the first spectrum range, and
the processing unit allocates an interference budget to the first communication device and reallocates an interference budget to a second communication device operated by the second operator, on a basis of a total amount of an interference margin in a protection area of a protection target system and an interference budget that has been allocated to the second communication device, and the processing unit determines maximum transmission power of the first communication device and the second communication device on a basis of the individual interference budgets.

10. The communication control device according to claim 9, wherein
the processing unit acquires a priority order of the first operator and the second operator on a basis of an order in which the first operator and the second operator have been permitted to receive a license for the first area and the second area, and the processing unit determines an interference budget for each of the first area and the second area on a basis of the priority order, and
the processing unit allocates an interference budget of the first area to one or more of the first communication devices belonging to the first area and allocates an interference budget of the second area to one or more of the second communication devices belonging to the second area.

11. The communication control device according to claim 10, wherein
the processing unit determines an interference budget for each of the first area and the second area, further on a basis of a number of the first communication devices belonging to the first area and a number of the second communication devices belonging to the second area.

12. A database device comprising:
an information acquisition unit configured to acquire information regarding an area and a spectrum range for which acquisition of a license for spectrum use has been permitted for each of a plurality of operators;
a registration unit configured to register, in a database, licensing data in which information regarding each of the operators, information regarding the area, and information regarding the spectrum range are associated with each other, on a basis of the information acquired by the information acquisition unit;
a reception unit configured to receive a provision request from a communication control device that controls allocation of an interference budget, the provision request requesting, for a target spectrum range, provision of a priority order of the operators regarding allocation of the interference budget regarding a protection target entity;
a processing unit configured to determine a priority order of the operators on a basis of an order of the operators for which the licensing data including information regarding the target spectrum range indicated in the provision request is registered in the database; and
an information providing unit configured to provide the communication control device with information regarding a priority order of the operators.

13. The database device according to claim 12, wherein
the database associates the licensing data with a time at which the licensing data is registered in the database, and
the processing unit determines a priority order of the operators on a basis of the time associated with the licensing data.

14. The database device according to claim 12, wherein
the processing unit generates a list holding an order of operators for which the licensing data for the spectrum range has been registered in the database, and determines, on a basis of the list, an order of the operators for which the licensing data has been registered in the database.

15. A communication control method comprising:
receiving a licensing request including information regarding a first area and a first spectrum range for which a first operator desires to acquire a license regarding spectrum use;
determining whether or not to permit acquisition of the license by the first operator on a basis of the licensing request and licensing data including information regarding a second area and a second spectrum range for which a license has been acquired by a second operator; and
transmitting a licensing response including information according to a determination result as to whether or not to permit acquisition of the license.

16. An information processing method comprising:
acquiring information regarding an area and a spectrum range for which acquisition of a license for spectrum use has been permitted for each of a plurality of operators;
registering, in a database, licensing data in which information regarding each of the operators, information regarding the area, and information regarding the spectrum range are associated with each other, on a basis of the acquired information;
receiving, from a communication control device that controls allocation of an interference budget, a provision request for requesting, for a target spectrum range, provision of a priority order of the operators regarding allocation of the interference budget regarding a protection target entity; and
determining a priority order of the operators on a basis of an order of the operators for which the licensing data including information regarding the target spectrum range indicated in the provision request is registered in the database, and providing the communication control device with information regarding a priority order of the operators.
